(19) United States
(12) Patent Application Publication
(10) Pub. No.: US 2015/0142486 A1
(43) Pub. Date: May 21, 2015

(54) SYSTEMS AND METHODS FOR CLOUD-BASED DIGITAL ASSET MANAGEMENT

(71) Applicants: Vince Broady, Santa Monica, CA (US); Scott Bedard, San Carlos, CA (US); Ankarino Lara, Pasadena, CA (US); John Broady, Dallas, TX (US); Conor Egan, San Francisco, CA (US); Mark Petersen, Orinda, CA (US); Adam Buchen, San Francisco, CA (US); Trey Walker, Berkeley, CA (US)

(72) Inventors: Vince Broady, Santa Monica, CA (US); Scott Bedard, San Carlos, CA (US); Ankarino Lara, Pasadena, CA (US); John Broady, Dallas, TX (US); Conor Egan, San Francisco, CA (US); Mark Petersen, Orinda, CA (US); Adam Buchen, San Francisco, CA (US); Trey Walker, Berkeley, CA (US)

(21) Appl. No.: 14/542,637

(22) Filed: Nov. 16, 2014

Related U.S. Application Data
(63) Continuation-in-part of application No. 13/772,305, filed on Feb. 20, 2013.
Application No. 13/772,305 is a continuation-in-part of application No. 13/644,389, filed on Oct. 4, 2012.
(60) Provisional application No. 61/905,266, filed on Nov. 17, 2013.

(51) Int. Cl. G06Q 10/06

(52) U.S. Cl. CPC G06Q 10/0631
USPC 705/7.12

(57) ABSTRACT

The present invention relates to systems and methods for cloud-based digital asset management. In some embodiments, the cloud-based digital asset management accesses one or more digital asset platforms. Digital assets are collected from these platforms. The digital assets include metadata and may be designated as pending. A user has the ability to update the digital assets status to an approved status. The approved digital assets may then be published to digital asset platforms. Publishing may be performed as a one-click publishing if the user ID is linked to one or more social media accounts. Publishing may also be performed batch wise. The digital assets may also be organized into playlists to facilitate digital asset management and publishing.

### CROSS REFERENCE TO RELATED APPLICATIONS

This non-provisional application claims the benefit of and is a continuation-in-part of co-pending U.S. provisional patent application No. 61/905,266, filed on Nov. 17, 2013, entitled “Systems and Methods for Cloud-Based Digital Asset Management.”

Also, this application is a continuation-in-part of U.S. patent application Ser. No. 13/772,305, filed on Feb. 20, 2013, entitled “Systems and Methods for Automated Channel Addition,” which in turn is a continuation-in-part of U.S. patent application Ser. No. 13/644,389, filed on Oct. 4, 2012, entitled “Systems and Methods for Automated Reprogramming of Displayed Content.”

All applications listed above are hereby fully incorporated in their entirety by this reference.

### BACKGROUND

The present invention relates to cloud-based digital asset management systems and methods for management and processing of digital assets stored in multiple locations and on multiple third-party platforms in a consistent and seamless manner. Such systems and methods are particularly useful in the context of online activities, and may be especially useful in social media and marketing. Such systems and methods enable marketers to leverage assets located on diverse platforms for rapid management and publishing of said assets.

Currently, people engaged in sales and marketing activities, including advertisers, brand managers, social media managers, and sales representatives, [administrative users and basic users] are unable to have a consolidated management system through which assets stored on third-party platforms can be managed, categorized or published on a seamless and consistent basis. As such, these users are forced to resort to access each platform separately, and register and manage content on each platform respectively. This process is time consuming, does not allow for consistent processing or management of the assets, and may result in missed opportunities for asset dissemination.

Likewise, these users are forced to utilize separate systems to register assets, and share assets within an organization or among organizations. For example, a marketer may have an internal intranet with shared folders for internal asset dissemination. However, since this system is independent from the third-party media platforms, often the most recent iteration of the asset is not rapidly registered, or even wrong versions of the asset get inadvertently registered.

Similarly, existing digital asset management systems do not enable users to apply the same functions to assets stored on third-party platforms that they do to assets stored within the management system or on servers controlled by the user.

For more casual users, in order to access all of their desired assets, they must likewise visit each platform independently. While content may be embedded into a central site, such as Facebook, these embedded items of content lose functionality typically available through a content management system, and are not as accessible.

It is therefore apparent that an urgent need exists for systems and methods for a digital asset management system that manages and processes digital assets stored in multiple locations and on multiple third-party platforms in a consistent and seamless manners. Such systems and methods would be able to provide marketers and other users the ability to consolidate and disseminate assets from multiple native platforms.

### SUMMARY

To achieve the foregoing and in accordance with the present invention, systems and methods for cloud-based digital asset management are provided. Such systems and methods enable marketers the ability to consolidate, manage and disseminate assets from and to multiple platforms.

In some embodiments, an asset management system is able to access one or more third-party platforms. The location of these assets on these platforms is registered. Metadata associated with these assets is obtained from the platform and included in the asset management system. Additional metadata may be associated with the asset through the asset management system. The status of the usability of the assets for various purposes may be designated. A user has the ability to update the asset status. The asset may then be published to multiple platforms and distribution points.

Permission to use the asset may be requested of the owner of the asset through the asset management system. The asset management system may interact with the third-party platform to use the communication tools of the third-party platform to send the request for permission and receive the owner's response. The asset may be blocked from publication pending permission of the asset owner to use the asset.

Publishing may be performed as a one-click publishing if the user ID is linked to one or more social media accounts. Publishing may also be performed batch wise. Prior to publishing the content may be placed into cards. Cards are essentially wrappers including functionality, which functionality may be tailored to the platform the content is being published to.

Analytics may be generated for the published assets. These analytics may include unique views, new views, geographic distribution of viewers, amount of time a video is viewed, video view drop rates, social sharing metrics, and contextual impressions.

The assets may also be organized into playlists to facilitate content management and publishing. In some embodiments, one or more playlists may be associated with a distributed engagement channel.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram illustrating users engaging an asset management system capable of cloud-based digital asset management, in accordance with some embodiments;

FIG. 2 is an example block diagram for the asset management system which includes a cloud-based digital asset management system-based digital asset manager, in accordance with some embodiments;

FIG. 3 is an example flow chart for the process of a automatically adding a channel, in accordance with some embodiments;

FIG. 4 is an is an example flow chart for the sub-process of content selection, in accordance with some embodiments;

FIG. 5 is an example flow chart for selecting the best content for the specific user, in accordance with some embodiments;

FIG. 6 is an example flow chart for feedback analysis, in accordance with some embodiments;

FIG. 7 is an example diagram for a template form which channels complete in order to gain compatibility with the automated channel addition, in accordance with some embodiments;

FIG. 8 is an example screenshot of a social network site, in accordance with some embodiments;

FIG. 9 is an example block diagram for the cloud-based digital asset manager, in accordance with some embodiments;

FIG. 10 is an example flow chart for operation of the cloud-based digital asset manager, in accordance with some embodiments;

FIG. 11 is an example flow chart for the browsing of digital assets, in accordance with some embodiments;

FIG. 12 is an example flow chart for registering digital assets, in accordance with some embodiments;

FIG. 13 is an example flow chart for publishing digital assets, in accordance with some embodiments;

FIGS. 14-40 are example screenshots for a cloud-based digital asset management system, in accordance with some embodiments; and

FIGS. 41A and 41B are example illustrations for computer systems configured to embody the cloud-based digital asset management system including cloud-based digital assets, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to novel means, systems and methods for cloud-based digital asset management. These systems and methods may be particularly useful within [social media] [online] settings, where digital assets are distributed across a number of platforms which are independent from one another.

Note that while much of the discussion contained herein relates to content sources through social networks, it is entirely possible that any content source may be utilized by the disclosed systems and methods. For example, media sources, such as YouTube, news outlets, such as CNN online, and online retailers, such as Amazon, may all be considered “content sources” for the purposes of this disclosure.

Further, some content sources may also be channels through which digital assets that have been registered and managed through the asset management system may be distributed, referred to as “distribution channels. For example, Facebook, YouTube and Twitter may be both content sources and distribution channels.

Further, marketers may likewise be referred to as “ad providers”, “advertisers”, or even “users”. For the purposes of this disclosure, the term “marketers” may include any generator or collector of digital assets. These include social network managers, casual users, content generators, advertisers, brand managers, brand owners and the like. When these marketers are interfacing with the digital asset management system they are also referred to as the “asset management system users.”

Further, while the term “digital asset” or “asset” is utilized extensively within this disclosure, these terms are inclusive of content, applications, and other digital information. For example, a video may be a digital asset, as may be text, images, or applications and additional digital information.

Lastly, Internet users may post digital assets to social networks, which assets the marketer may wish to register into the digital asset management system. Internet users may also view content distributed by the marketer via the digital asset management system through the social network or through other channels controlled by the marketer, and may be actual or prospective customers of the marketer. These Internet users may be referred to as “end-users.”

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Digital Asset Management System

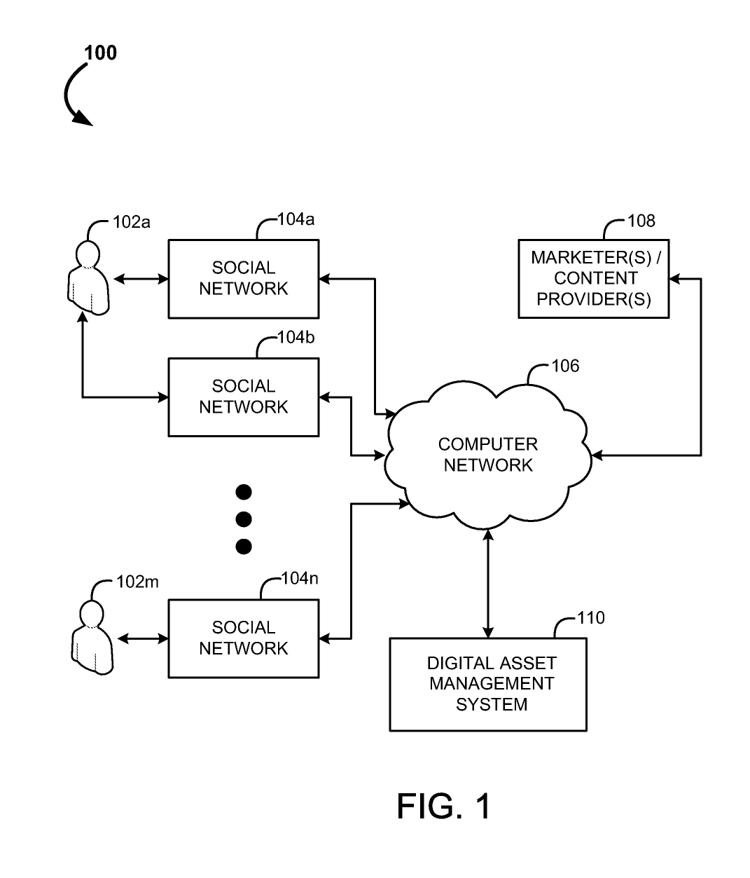

The cloud-based digital asset management system disclosed herein may be part of a more inclusive digital asset management system. Thus, to facilitate the discussion, FIG. 1 is an example functional block diagram 100 illustrating end-users 102a to 102m engaging social networks 104a to 104n in conjunction with a digital asset management system 110 that tailors the digital assets displayed, delivers interactive advertisements, and provide cloud-based digital asset storage and management capabilities. In this particular example illustration, two end-users 102a to 102m are seen interacting with one or more social networks (channels) 104a to 104n. While social networks 104a to 104n are illustrated in this example illustration, it is considered within the scope of this disclosure that a wide variety of websites may be accessed by the end-users 102a to 102m, including entertainment sites, news outlets, retailers, search engines, blogs, informational and reference pages, websites for organizations, social media sites, branded websites, or any other distribution channel accessible by a user.

The social networks 104a to 104n are accessed by the end-users 102a to 102m via a computer network 106. In some embodiments, the computer network 106 is the internet; however, it is possible that the computer network 106 may include any wide area network, local area network, company network, interactive television network, etc. The computer network 106 additionally couples the social networks 104a to 104n to a digital asset management system 110 and marketers or other asset providers 108.

The marketer/asset management system user 108 may provide digital assets (videos, images, advertisements, applications, etc.) directly to the digital asset management system 110 from systems under the marketer's control (databases, local or cloud-based servers, etc.) for storage in the cloud-based databases associated with the system. Marketers or other asset providers 108 may also include groups such as brand managers, administrative users and the like. Further, in addition to providing content or other digital assets directly to the system, the marketers/asset management system users 108 may collect content from the various third-party content platforms 104a to 104n, which may include social networks, through the APIs offered by those platforms, and which content may continue to be hosted on the third-party content platform, and manage these remote assets using the cloud-based digital asset management system in the same manner as assets provided directly to the system. The assets located on the third-party content platforms may be owned by end-users or by the marketer itself.

The digital asset management system 110 is able to ingest content already present on a social network 104a to 104n via APIs. Alternatively, content may be directly uploaded to the social network 104a to 104n by the marketer 108.

Likewise, the social networks 104a to 104n provide a form providing the digital asset management system 110 the resources necessary to tailor the content to each specific API for each social network 104a to 104n. Thus, the marketer 108 is only required to provide one set of data to a single recipient in order to roll out advertisements to a wide number of channels. Likewise, this enables the cloud-based digital asset management system access to a variety of content platforms.

In addition to the other functionalities described herein, in some embodiments, the digital asset management system may also be able to filter or search third party content platforms, including social network streams, and collect online end-user content (and other assets) into the system for management and processing. Approval can be sought from the online end-users in order to utilize the user generated content. Such approval mechanisms are described in greater detail in co-pending application entitled “Systems and Methods for Closed Loop Confirmation”.

In some embodiments, an end-user 102a may access a third-party content platform or social network 104a. The third-party content platform or social network 104a provides the content that has been tailored by the digital asset management system 110 to the end-user 102a. In some cases, the content provided to the end-user 102a may not only be tailored to the API of the social network, but may even be selected by the content management system 110 from a variety of possible content. In these particular embodiments, the digital asset management system 110 operates in the background to analyze the sentiments of the user 102a to determine what content will be provided to the user. In these embodiments, the content management system 110 is capable of tying each user 102a to a persistent identification, and may be linked to the end-user's 102a identification in each social network they frequent. This persistent identification allows the sentiment of the user 102a to be tracked across various social networks 104a to 104n (or other social networks). This enables digital asset management system 110 to learn about the user 102a, develop a personality profile, and make more exact predictions regarding how the user 102a will react to any particular content.

Persistent identity may also be of use when collecting user generated content. For example, if it is known that a particular user generates high quality user content, and is often willing to grant approval to use the content, then it may be beneficial to track the user across a wide range of platforms.

In addition to collecting user generated content, the digital asset management system 110 may access statistical data generated by users on the social network. This feedback data on these channels may be tracked by the digital asset management system 110 and utilized for further operations, such as distributed engagement channel development (which is the display through digital engagement applications on multiple distribution points), improving content selection, and user analytics. This feedback data may be the number of “likes” for example, number of “shares”, number of friends or followers and comments by users.

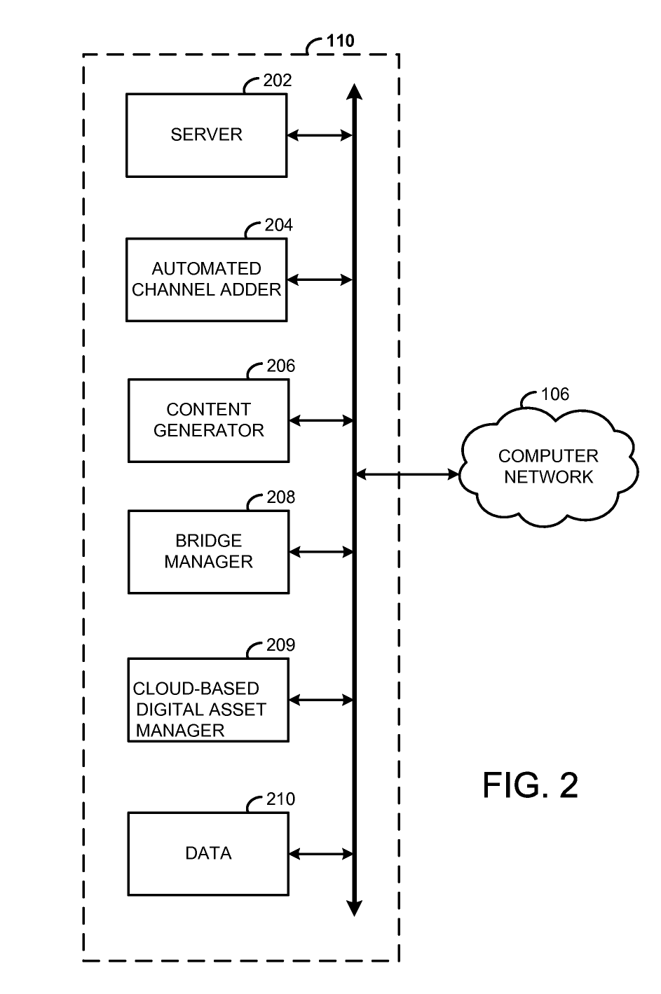

FIG. 2 is an example block diagram for the digital assets management system 110, in accordance with some embodiments. The system 110 includes a server 202, an automated channel adder 204, a content generator 206, an interactive bridge manager 208, a cloud-based digital asset manager 209, and one or more database 210. Each of these subsystems is a logical component of the digital asset management system 110 and is logically coupled to one another. In cases in which these subsystems are embodied within separate devices, or operating within a virtual environment, the coupling may be merely logical in nature. When these subsystems are embodied upon a single device, the coupling may include a physical connection, such as a central bus.

Each component of the digital asset management system 110 may likewise access the computer network 106. The server 202 may interact directly with the social networks 104a to 104n (or other content platforms) in order to provide the content selection for a given end-user 102a, as well as interact with the marketers/brand owners/content users/etc. 108. The cloud-based digital asset manager 209 may be the primary subsystem responsible for cloud-based asset hosting and access. The cloud-based digital asset manager 209 is described in significant detail below.

The interactive bridge manager 208, which is optional depending upon embodiment, may generate an interactive bridge button for inclusion in the marketing messages, which distributed digital engagement applications they link with, and which content (comments, live stats, etc.) they pull from. In some embodiments, the generated interactive bridge button may even include live statistics or other personalized content for the user. Likewise, the content generator 206 may utilize content to optimize it for each social network as will be discussed in greater detail. An interactive bridge manager 208 and content generator 206 may improve the quality of content provided to the social networks for consumption by the user. It should be noted however, that while these quality improving functions improve user engagement; they are not required to perform automated channel addition, or cloud-based digital asset management systems, in some embodiments.

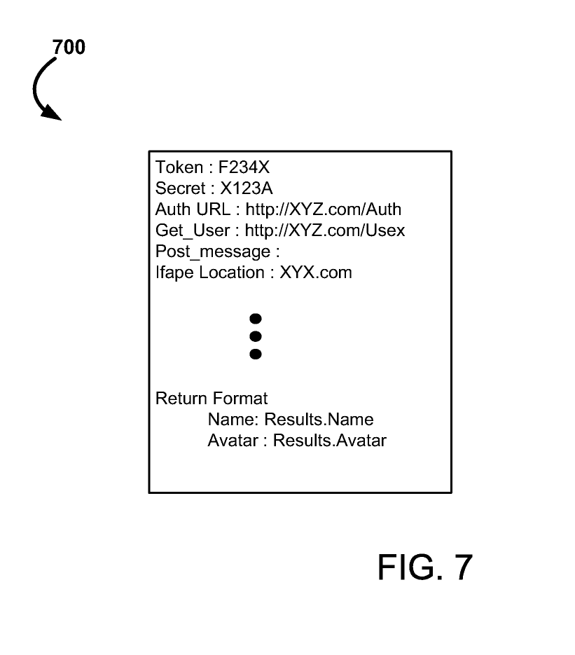

The automated channel adder 204 receives form data from the social networks 104a to 104n. An example of the form data received may be seen in relation to FIG. 7, at 700. The form data includes a token, secret, authentication url, API endpoints to get a user or other entity's info, optional extra data schema, and SLA relating to rate-limiting or other performance-affecting factors. The automated channel adder 204 can utilize the form data for configure the marketer's content to be compatible with each of the social networks APIs. Thus, the automated channel adder 204 may generate multiple versions of the marketer's 108 content which can be added to any supported channel in an automated fashion.

Although not shown, the content generator 204 may be employed by a sentiment analyzer in order to generate probabilities that the given user 102a will react positively to a given piece of content. The profiles, available content and social network API requirements (form data) may be stored within a database 210.

The cloud-based digital asset manager 209 provides a single location in which marketers, brand managers, administrative users and basic users to consolidate their digital assets from across multiple content platforms. This enables better sharing and management of content, and further enables efficient publishing of the appropriate content.

In the following sections, automated channel addition and cloud-based digital asset management systems will be disclosed in greater detail, respectively.

### II. Automated Channel Addition

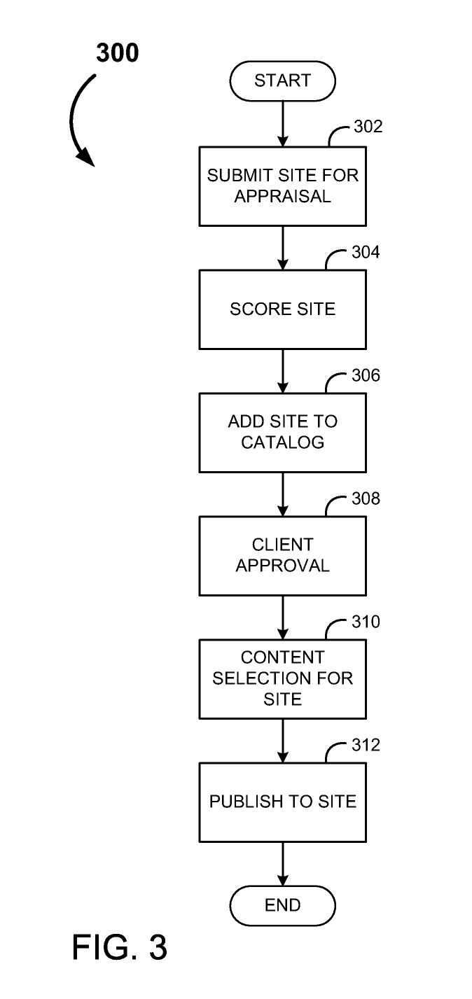

FIG. 3 is an example flow chart 300 for the process of an advertiser engaging with a content management system for automated channel addition, in accordance with some embodiments. In this process a social network (or other channel) may access the content management system. The site is submitted for appraisal by the content management system (at 302). Site submission may include providing the form data, as previously discussed in relation with FIG. 7. The form data may include an Atom XML file or equivalent. This form data is similar to existing procedures employed by Google's Hub, and as such is something social networks are already doing, thereby promoting adoption or buy-in of the presently disclosed system.

Generally the channel seeks out the content management system in order to submit their site for assessment. However, in some cases the channel may not be aware of the system. In those cases, the system could, periodically, automatically scrape the web looking for new channels. Upon finding a new one, the system could invite the new channel to submit a form per the above described step.

Next the content management system scores the site (at 304). Site scoring is not presently performed by any other system currently, as disclosed, for the automated addition of channels for advertisement distribution. Site scoring includes cataloging each participating channel (social network, etc.), and generates a score values for each site based upon the number of users, topics of conversation, sentiments on these topics, and level of user engagement. These scores may be a single composite value of the site, or may be scored in various categories. For example, a site for technophiles may have a relatively small user base, and a narrow scope of topics, but the sentiments may be high regarding this topic and its users very active. As such, an overall value score would be low, but a value score in the area of high-end technology may be high. This scoring process provides guidance to marketers which channels they are of most value to the specific advertiser. One such scoring algorithm would be: [(proportionate change in monthly active users)/sqrt([domain variety score]/[monthly active users])]*(# of users of that channel on DEC/total # users across all DEC platform).

After site scoring, the site and score are added to a catalog (at 306) for rapid and easy access. Next, the scored and cataloged social network site (or other channel) is presented to the advertiser client for approval (at 308). This approval may proceed in alternative ways, depending upon embodiment.

In some embodiments, a social network desires to join the marketing platform's delivery system without requesting specific advertising content. In that scenario, the content management system performs a matching function that matches certain social networks with certain marketers depending on matching criteria.

From the advertiser point of view, these additional social networks may appear as additional possible channels for their content, beyond the main channels of Facebook, YouTube, etc. The advertiser's approval of the new social network can occur, for example, when the advertiser selects that social network as a channel for advertising.

In some other embodiments, the social network is interested in particular content of the advertiser handled by the content management system. For example, the users of the social network might be talking about a particular movie for which the content management system has advertising content for.

In that case, the social network can request that particular content of that advertiser in the form of the first step above. That request is presented to the advertiser which then can accept or reject the request.

Once the advertiser (client) approves the display of content on the social network, the system may select which content is to be advertised on the site (at 310). In some cases, a particular advertisement may be pushed by the advertiser, or requested by the channel, in which case these desires may influence the content selection. Alternatively, in some cases a very limited set of advertisements may be available. In this case, the selection step may be trivial. However, in circumstances where a number of advertisements (or other content) are available for publishing on the channel, it may be desirable to perform improved sentiment driven content selection in order to improve the impact of the published content.

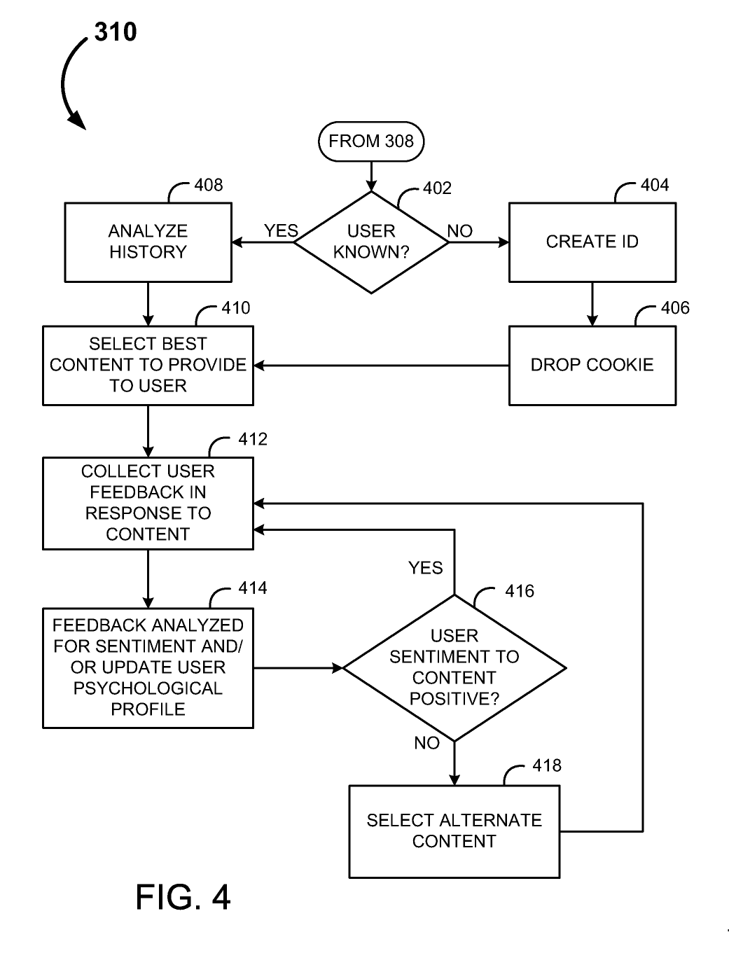

FIG. 4 provides an example process of generating tailored content for a user by based upon user sentiment (at 310). In this example process, initially a decision is made whether the user accessing the content provider is known (at 402). Users are “known” when they can be tied to a psychological profile. The content selection component of the content management system may identify tracking cookies upon the user's computer (or other computational device, such as tablets, mobile devices, etc.). If no identifying cookie exists, some embodiments of the automated reprogramming system may alternatively identify the user by device MAC address or other indication. In some embodiments, the user is known if she is logged into the social network (or other channel). For example, a user must supply a password and username to access their profile in Facebook or Twitter. The channel can use this authentication process in order to inform the content management system of the user's identity. By leveraging both login data and cookies, the content management system may be able to track users even when they are using different devices, and across different unrelated websites.

If the user is known, the user's history is analyzed (at 408). History analysis may include accessing the user's psychological profile from storage. Alternatively, if the user is not known, an ID may be generated for the user (at 404) which is associated with a new user psychological profile. The new psychological profile may be blank initially, or may include one of potentially several default profiles based upon “stereotypical” users that access the content provider, or otherwise based upon the user's activity. After the user ID is generated, the automated reprogramming system may drop a cookie (at 406) in order to facilitate tracking the user across various content providers (such as Twitter and Facebook, for example).

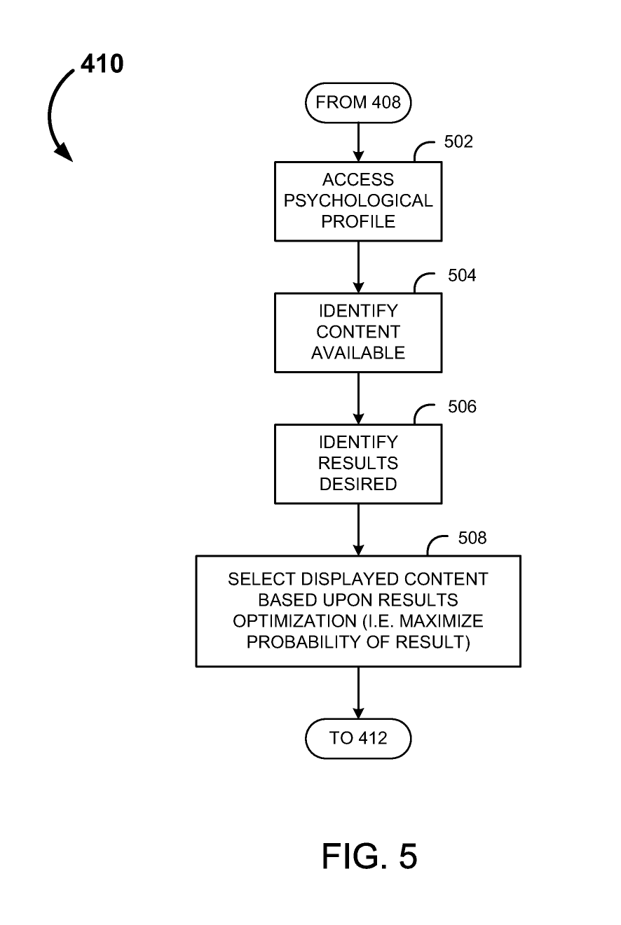

Once the psychological profile has been retrieved from storage (or newly generated), the system selects the best content to provide to the user (at 410). Turning to FIG. 5, an example flow chart for this sub process of content selection is illustrated. This process accesses the user's psychological profile (at 502). The psychological profile may include any number of variables that can be utilized to model user response to content. Typically, a psychological profile may include sentiments, interests, demographics, state of mind, habits, and networks, for example. Sentiments may indicate an overall personality such as “negative”, or “optimistic”. Interests may include topics the user is interested in, such as “movies”, “fashion” or “food”. Demographics may include information such as age, race, gender, and socioeconomics. State of mind may include overarching themes the user is involved in, such as “getting married”, “having a baby”, “buying a house” or other such life events that are persistently impacting the user. Habits may include behavioral habits such as being a “purchaser” or “sharer”. Network may include the user's friend lists and other contacts.

The system also queries the database for the content that is available for display to the user (at 504). The desired result is then determined by the system (at 506). The desired result, in the case of an advertisement, may include the user clicking upon the ad, or accessing the website that the advertisement is promoting. If the content is non-advertisement material, the desired result may include staying longer on the webpage, or exploring the content in greater detail. Other desirable results may include sharing of the content, making a purchase, broadcasting the content, or building up reputation of the content (typically through positive comments).

Once the system identifies which result is desired, it then models the probability of that result occurring for each of the available content based upon the user profile (at 508). This modeling may compare how other users with similar psychological profiles reacted to the content in order to build a probability function where each category in the psychological profile is a variable. The system may then optimize for the largest probability of the result occurring, given the available content. The identified content may be selected for display. In some embodiments, vector similarity may be employed to match the user profile to content. Content may be recommended via user-item collaborative filtering. Recommendations obtained from both content similarity and collaborative filtering may then be ranked using weights calculated from feedback and displayed to user, in some embodiments. Users may also be matched to one another using vector similarity, or comparable analytic techniques.

Returning to FIG. 4, once the content has been selected and displayed, the system collects feedback from the user (at 412) in response to the content. This feedback may include a comment, a desired result, or some other action by the user. The feedback may be analyzed for sentiment and the user's psychological profile may be updated (at 414).

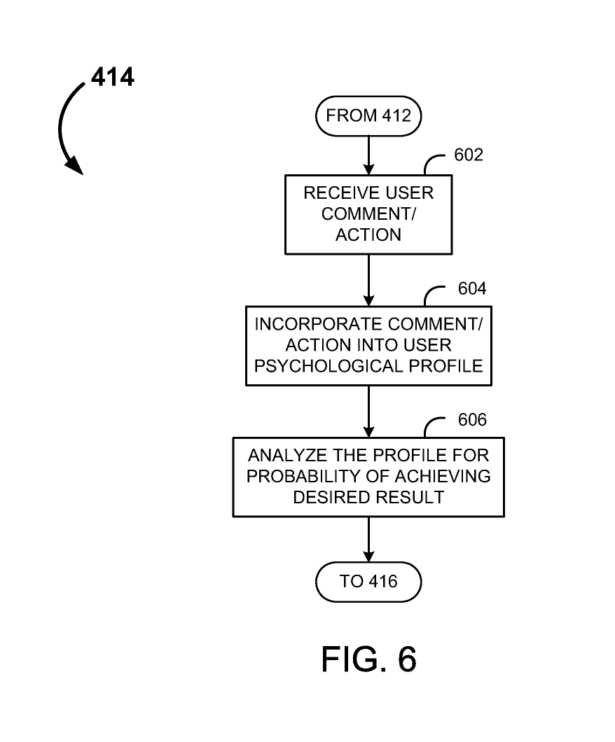

Turning now to FIG. 6, an example flow chart for the process of feedback analysis is illustrated. In this example process, the user's comment or action is received (at 602), and the comment or action is incorporated into the user psychological profile (at 604). For example, assume the user provides feedback to content including a comment of “Stop testing on animals”. The system may parse the comment, and perform syntactical analysis on the parsed comment. Based upon the analysis, the system may determine that changing the content is appropriate. It may also be possible that the comment may be analyzed for factual accuracy, and if inaccurate, content illustrating facts may be presented. For example, assume the brand being commented upon does not do animal testing. The system may then provide the user with a video illustrating how testing is performed in order to alter the negative opinion the user has of the brand. Similarly, if the comment was a question, such as “How do I do x?”, the system may provide videos or other content around that function. In a third example, the user states “I love this product.” In response, the system may provide content of the next version of the product. Conversely, if the user states “I hate this product”, the system may instead provide content of the product (or brand's) best feature. It is possible to analyze for Sentiment, Content and Context to build the profile and display appropriate content.

After the profile has been updated, it is again analyzed for the probability of achieving the desired result (at 606) in a manner similar to that discussed above. Returning to FIG. 4, the system determines if the user's sentiment is positive (at 416), and if so, maintains the content and awaits further user feedback. However, if the user reacts negatively to the content, then the system may select alternative content (at 418) using the updated psychological profile and probabilities.

In this manner, the system may build out a robust psychological profile for the user and leverage the profile to maximize the chance that content will have a desired result. If the system receives a negative feedback from the user, the profile is updated, and the content reviewed for alternatives. This ensures the user is consistently provided relevant and desirable content.

Further, by utilizing a cookie tied to the user's ID, the system is able to track the user across different content providers' platforms. Thus, comments on a Facebook page may bolster the user's psychological profile and alter the content the user may experience on an entirely different portal, such as YouTube.

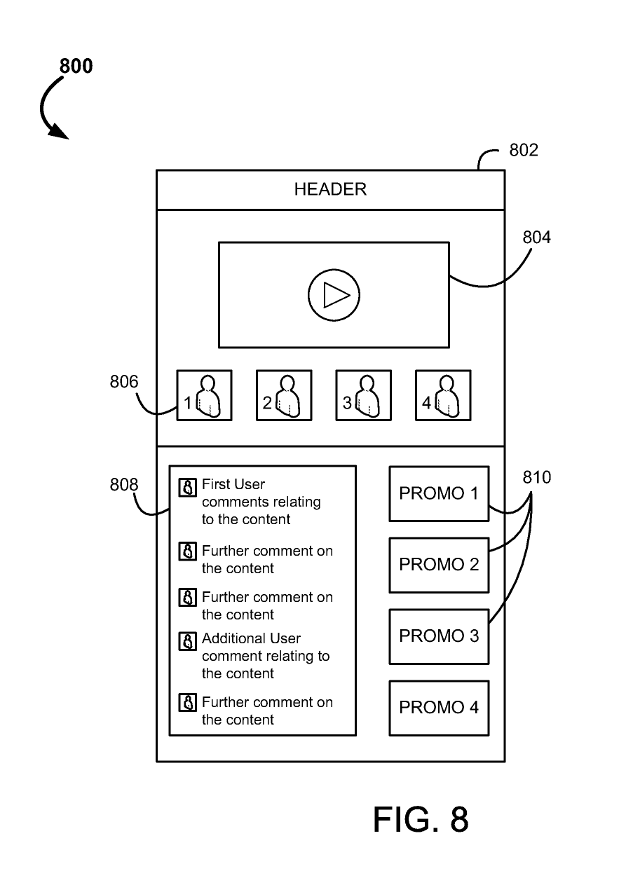

FIG. 8 is an example screenshot 800 of a channel webpage in which the automated channel addition system may be employed, in accordance with some embodiments. In this example screenshot, a header 802 is displayed, below which a primary content 804 is presented. Alternate content 810 is highlighted in a sidebar in this example. This example screen also includes a comments section 806. The users are displayed in thumbnails 808. The system logs the users' activity on the page. In some embodiments, a table of activities may be generated in the following format:

| User | Date/ | Content | User | | Facebook | | Twitter |
|---|---|---|---|---|---|---|---|
| ID | Time | Description | Action | Object | ID | . . . | ID |
| 1 | 9-13 | Brand 1 | Media | 2 | Stacy2012 | . . . | |
| | 11:00 | | View | | | | |
| 1 | 9-14 | Brand 1 | Comment | Stop testing | | . . . | SMiller8 |
| | 12:32 | | | on animals | | | |
| 1 | 9-14 | Brand 2 | Show times | 4 | Stacy2012 | . . . | |
| | 2:43 | | | | | | |
| 2 | 8-29 | Brand 1 | Media | 2 | MerryMan | . . . | |
| | 9:02 | | View | | | | |

As can be seen in the example table, each user is given a user ID (persistent identification) that is independent from other content provider IDs. While the table is illustrated as including Facebook and Twitter, typical data sets will include a very large number of channels, where the user's ID can be associated with an ID native to each channel.

Using this example table's dataset, a user ID number 1 was recorded viewing a Brand 1 media clip on September 13^{th} on her Facebook account. The same user then posted a comment on Twitter on September 14 stating “Stop testing on animals.” Sentiment analysis on the comment determines that this user has reacted badly to the content displayed on Facebook, and alternate content may be selected for display to the user. This sentiment analysis may be performed upon subsequent page loading, or may be performed instantly once a negative sentiment is received. In this way, it may be possible to replace offending content as rapidly as possible in order to protect the marketers, and also to maintain user satisfaction. Below the process for reprogramming content on the social networks 104a to 104n, and other content providers, will be described in greater detail.

Returning to FIG. 3, after the content has been selected, the system may publish the selected content to the channel (at 312). This publishing step utilizes the form data provided by the social network, or other channel, to tailor the content to that channels API.

Optionally, a further step may be performed (not illustrated) in which the system determines payment to the channel for prompting its users to engage with the marketing platform. Currently, when marketers manually connect to social networks, the marketers do not pay the social network for access to the social networks users. However, since the social network (or other channel) needs to initially request connection and provide their site for appraisal, a cost per engagement model may be employed to incentivize active participation by social networks.

This system and process for automated channel addition may be the first, ideal application for cost per engagement remuneration. Ultimately, what this system delivers to the marketers is the engagement of social network users. A cost per engagement pricing model ensures that there is payment to the social network only if there is actual, measured engagement. Thus, with automated channel addition, advertiser motivation matches precisely what the social network actually delivers.

Another reason why automated channel addition may be the ideal application for cost per engagement is that via automated channel addition, the content management system is the entity that directly captures and records the engagement activity of social media users, including comments, “likes”, “sharing” etc. Since the content management system is a third party between the advertiser and the channel, there is no incentive for the content management system to inflate or deflate the recorded engagement metrics.

As an alternative to or in parallel with cost per engagement compensation, the content management system could provide a gamification experience for these smaller channels that connect with the platform in the way disclosed herein. In this gamified experience, these social networks would compete for badges, rankings on leaderboards and such in order to get favored placement by the platform in front of the marketers.

### III. Cloud-Based Digital Asset Manager

Now that the addition of channels has been described, attention will be turned toward the systems and processes of a cloud-based digital asset manager. As previously noted, the cloud-based digital asset management system enables marketers (including advertisers, brand managers, administrative users and basic users) the ability to consolidate and manage content across a wide range of independent content platforms. Additionally, the cloud-based digital asset management system enables easy and seamless publishing of content to a variety of content platforms.

The various users may leverage the cloud-based digital asset management system differently based upon their needs. For example, a brand manager can use the cloud-based digital asset management system to store all official marketing assets for internal and external dissemination. A social media manager could use the cloud-based digital asset management system to rapidly publish approved content to available distribution channels including social media platforms. An administrative user could utilize the cloud-based digital asset management system such that marketing assets are controlled such that only approved assets are released to a broader market. Additionally, the administrative user can create meta-data points for all content to ensure proper tagging, and manage approver, editor and basic user privileges. Meta-data is all data associated with any content item. The basic user may use the cloud-based digital asset management system to collect their content from a variety of content platforms, as well as storing their original content.

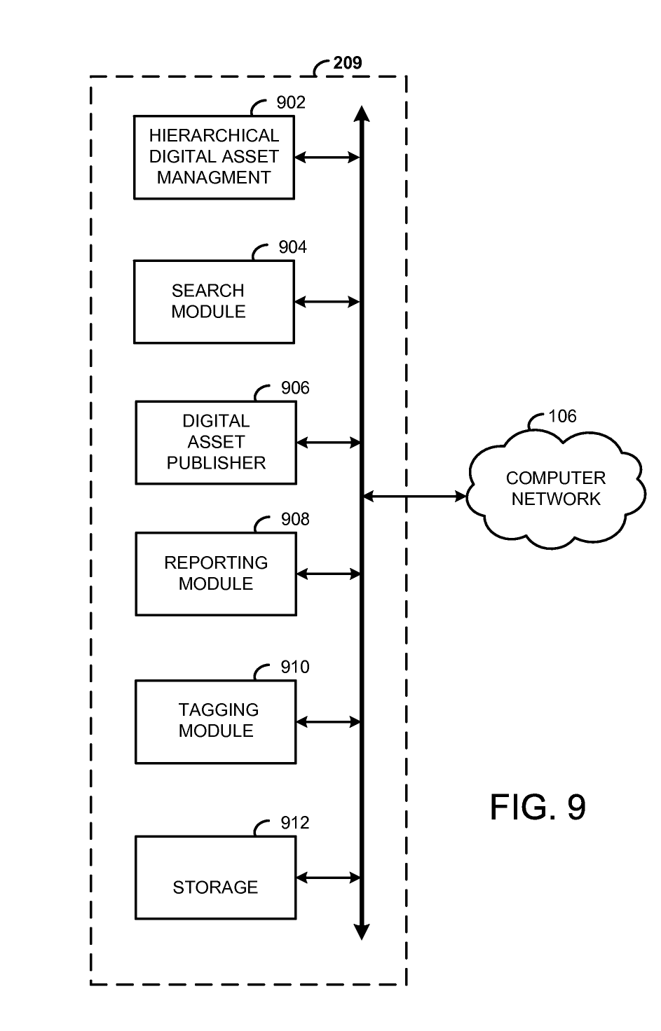

FIG. 9 is an example block diagram for the cloud-based digital asset manager 209, in accordance with some embodiments. The cloud-based digital asset manager 209 includes a hierarchical content management module 902, a searching module 904, a content publisher 906, a reporting module 908, a tagging module 910, and content storage 912.

The hierarchical digital asset manager 902 provides different functionality for the user based upon their status. A user may be an administrator, an approver, and editor or a basic user. An administrator may have the ability to add, edit and delete user accounts, add or remove publishing permissions for other users, and add, edit, approve and publish digital assets. In contrast, an approver may add, edit and approve digital assets, and may have limited account management. An approver may also be enabled to publish digital assets with assigned permissions. An editor may have more restricted access to digital assets (add and delete ability for owned digital assets). Editors may also be enabled to publish digital assets with assigned permissions. However, these users may be unable to approve digital assets. Lastly, basic users may have limited viewing and publishing capabilities.

The searching module 904 enables users to search stored digital assets, as well as publicly available digital assets on the various third-party digital asset and social media platforms. This searching often includes keyword searches, as well as filters.

The digital asset publisher 906 module enables publishing of digital assets onto any such asset platform or social media platform where permissions are present or to distribution points owned or controlled by the marketer. Publishing may be performed via batch, one-click, or on an individual content asset basis. Various API's may be utilized to distribute the digital assets across the platforms. One-click publishing enables users to leverage a side panel to post digital assets to social media accounts in a streamlined fashion. Digital asset publishing will be disclosed in greater detail below in relation to exemplary screenshots.

The reporting module 908 may generate analytics for each article of digital assets or for assets that have been grouped into playlists. This may include its performance within specific digital asset platforms. For example, reports may include unique views, new views, geographic distribution of viewers, amount of time a video is viewed, video view drop rates, social sharing metrics, number of “likes”, contextual impressions, comments, shares, etc.

The tagging module 910 enables users to add tags to specific digital assets in order to facilitate searching. Likewise, the tagging module may enable customization of meta-data for digital assets, for users with sufficient permissions. Metadata may be associated with a user ID, in some embodiments. In other embodiments, metadata may be configured for the digital asset directly. Some metadata may date based which automatically switches digital asset from an approved or pending status to an expired status at a specific date.

The digital asset storage 912 may include database(s) where the digital assets are maintained. Digital assets, as previously discussed, may include virtually any content type; including but not limited to videos, images, text, executable files, etc.

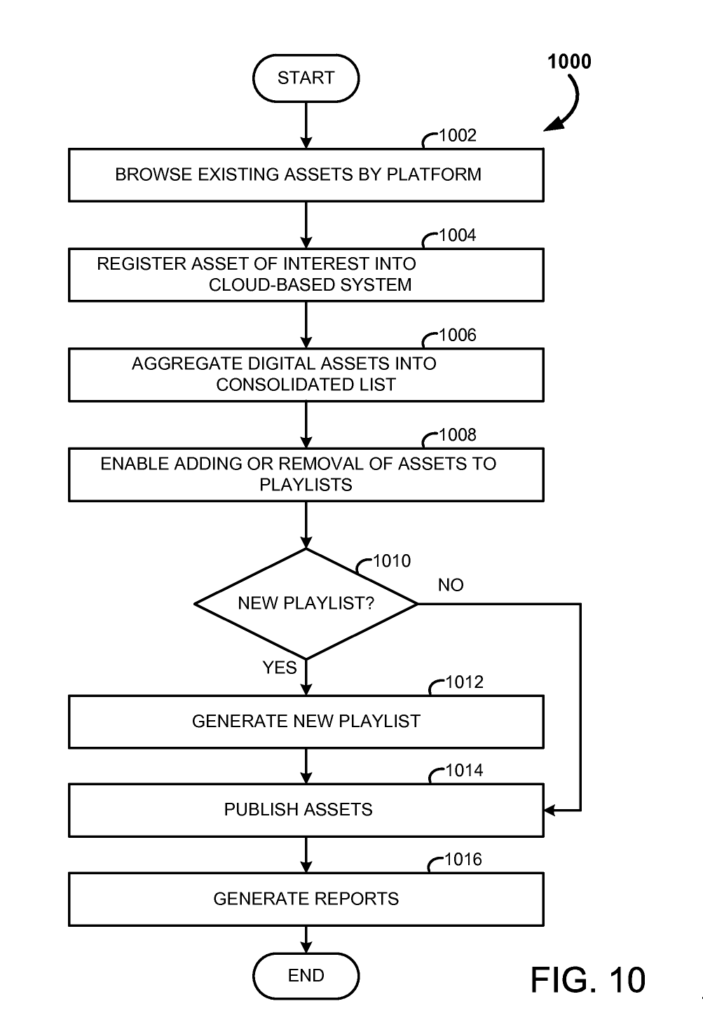

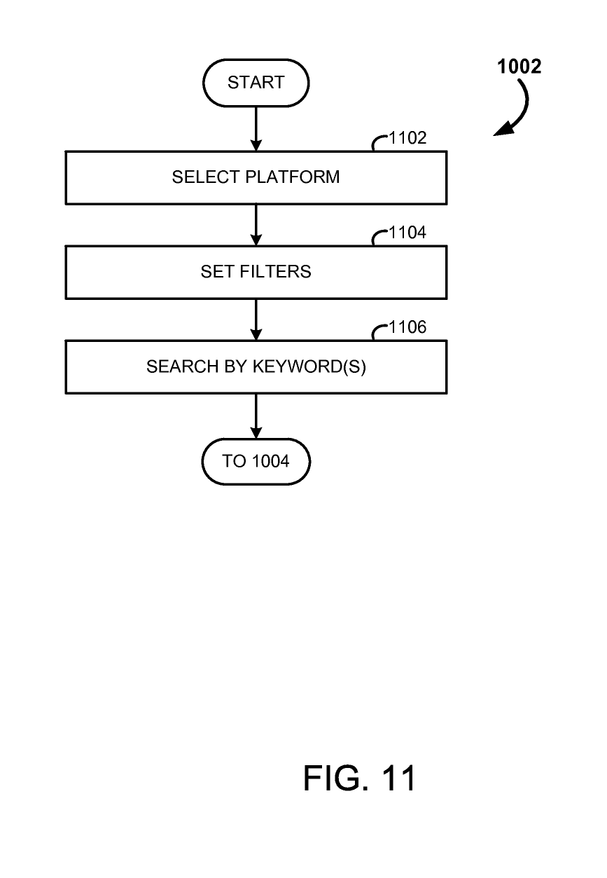

Turning to FIG. 10, an example flow chart for operation of the cloud-based digital asset management system is provided, as shown at 1000. This process begins with a user browsing existing digital assets within digital assets platforms (at 1002). This process of digital asset browsing is explained in greater detail in FIG. 11. The user first selects a platform for browsing, such as YouTube (at 1102). Then the user sets filters for the digital assets (at 1104). Filters include date of digital asset, type of digital asset, geographic regions, duration, tags, etc. The user may then search the filtered dataset by keywords (at 1106) to yield digital assets that are relevant to the user.

Returning to FIG. 10, the user may register digital assets of interest into the management system from the search results (at 1004). The user may then repeat the searches (not shown) for other digital assets, or on other platforms. Additional digital assets of interest may be registered to the cloud-based digital asset management system. Likewise, the user may be able to register original digital assets (such as a new marketing video developed internally).

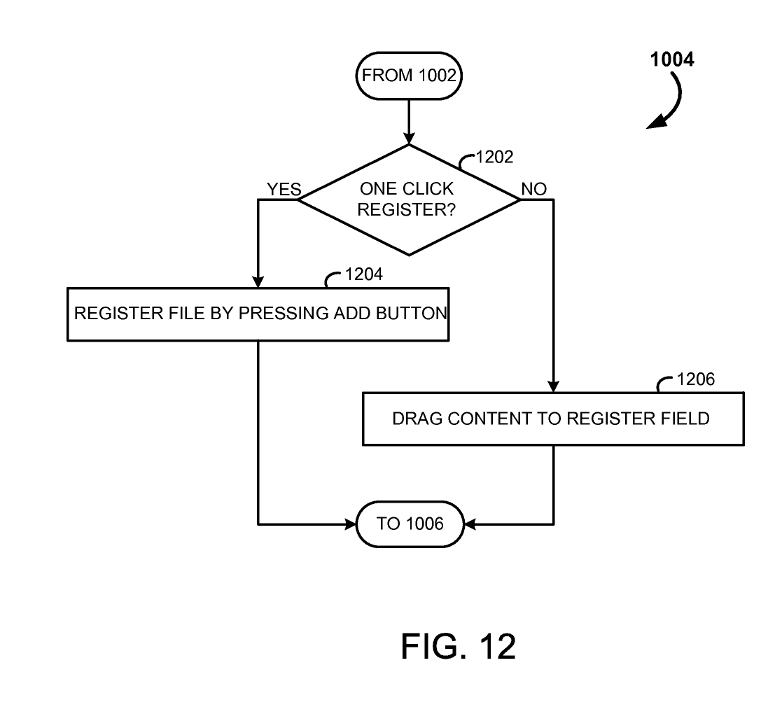

FIG. 12 illustrates the process for registering digital assets in greater detail. In this process, a determination is made whether a one click registration is desired (at 1202). If so, the digital asset is registered into to the digital asset management system once the management system user selects the “add” button on the displayed digital asset (at 1204) to register the digital asset to the system. Alternatively, the digital asset may be registered individually, or as a batch, via a drag and drop to an registration field (at 1206). Although not shown, original assets not located on third party platforms may be directly uploaded to the cloud based asset management system. These hosted files may be treated similar to registered assets.

A determination may also be made whether end-user consent is required in order to register the asset into the digital asset management system. If consent is required, then the digital asset management system will send a consent request to the end-user, which may be processed via a third-party social network on which the end-user posted the asset, and will record the response. Registration will only proceed where an affirmative response has been received.

Returning to FIG. 10, after a digital asset has been registered (or hosted where applicable) to the cloud-based digital asset management system, it may be aggregated into a consolidated grouping for the management system user's review (at 1006). The system enables adding/removal of the registered digital assets to playlists (at 1008). A playlist allows the management system users to categorize and efficiently manage the digital assets by grouping digital assets by similar type, brand campaign, target demographic, geographic region, etc. Playlist themselves may be configurable and sortable. The playlists may also be shared by the management system user or published to one or more external digital asset platforms.

The management system user may have the option to generate a new playlist (at 1010). If a new playlist is desired, the management system user can designate the playlist type and accessibility (at 1012). The digital assets can be assigned to the new, or an existing, playlist. Then the digital assets may be published to one or more external digital assets platforms (at 1014).

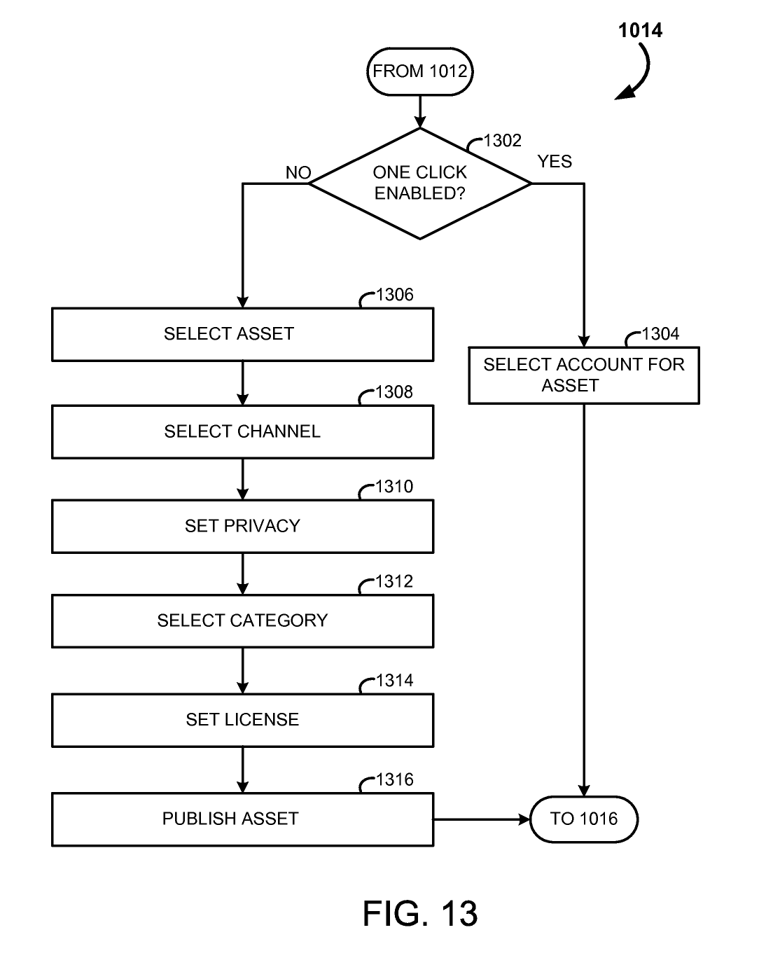

FIG. 13 provides a more detailed process for digital asset publishing. Like with digital asset registration, publishing may be performed via one click (at 1302). If one click publishing is desired, the user selects a social media account for the digital assets to be published to (at 1304), and the digital assets may be published. Alternatively, the digital assets (or batch of digital assets) may be selected (at 1306). A distribution channel for the digital assets is also selected (at 1308). Privacy settings for the digital assets may be assigned (at 1310). Digital assets category may also be selected (at 1312). Where applicable, a license policy for the digital assets may likewise be set (at 1314). Lastly, the digital assets may be published (at 1316).

In some embodiments, the digital cloud assets may be placed into “cards” prior to publication. Cards, as defined herein, are essentially wrappers around the actual asset (photo, video, etc.). The cards may dynamically take on functionality of the network that the content is being shared with, thereby making the content appear to be native to the network.

For example, if the card is on Facebook, the asset may dynamically include functionality such as the “like” and “share” functions that are associated with Facebook. The system may include different card wrappers for different social media platforms, such as Twitter, Instagram, etc.

As such, when a digital asset is published from the digital assert management system, it may be initially placed in the appropriate card based upon where the asset is being published to, in order to make the publication process as seamless as possible, and allowing published assets to appear native to the final destination. In this manner, assets may be managed from one location, and yet appear to all viewers as being natively uploaded on the end sites.

Returning to FIG. 10, after digital assets publishing, the system may generate reports for the digital asset (at 1016). As previously mentioned, reports may include any of unique views, new views, geographic distribution of viewers, amount of time a video is viewed, video view drop rates, social sharing metrics, number of “likes”, contextual impressions, etc.

Now that the process for cloud-based digital asset management system usage has been described in detail, a series of examples are provided to exemplify embodiments of the system. The following example screenshots are intended to clarify the above described system and methods, and are not intended to limit the scope of the disclosure to any specific embodiment.

### IV. Examples

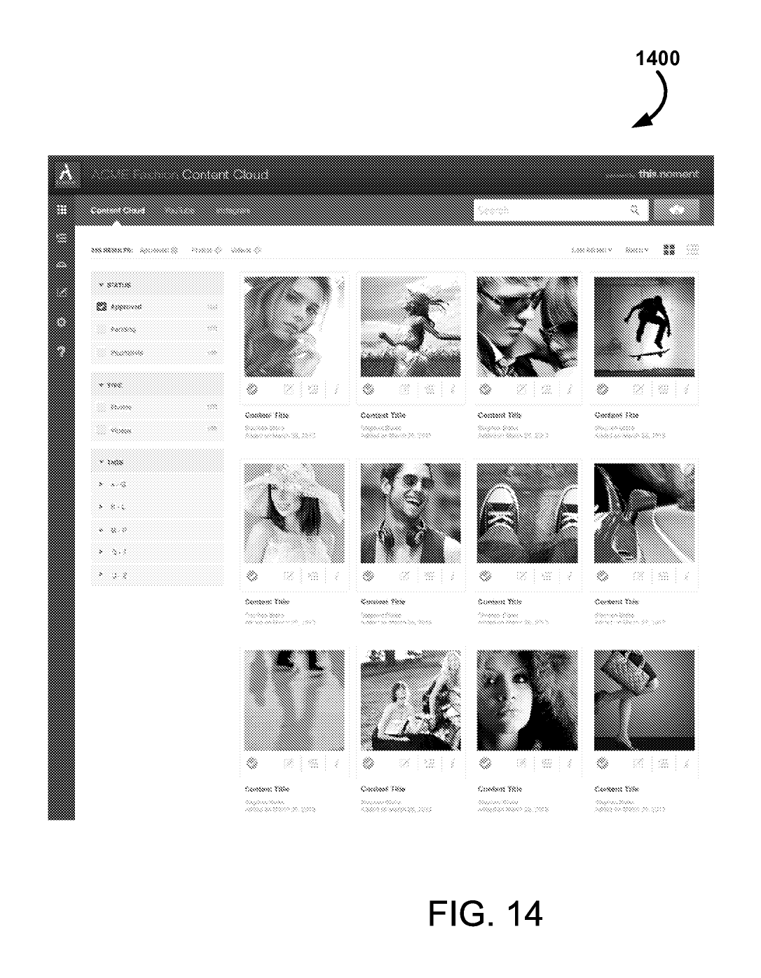

FIGS. 14-40 are example screenshots for a cloud-based digital asset management system, in accordance with some embodiments. FIG. 14, for example, illustrates one embodiment of a cloud-based digital asset management system dashboard (at 1400) where digital assets which has been already registered into the system is displayed. On the left hand side, a series of filters are provided to assist the user in organization of the digital assets. The user may also employ the search tool to find specific digital assets.

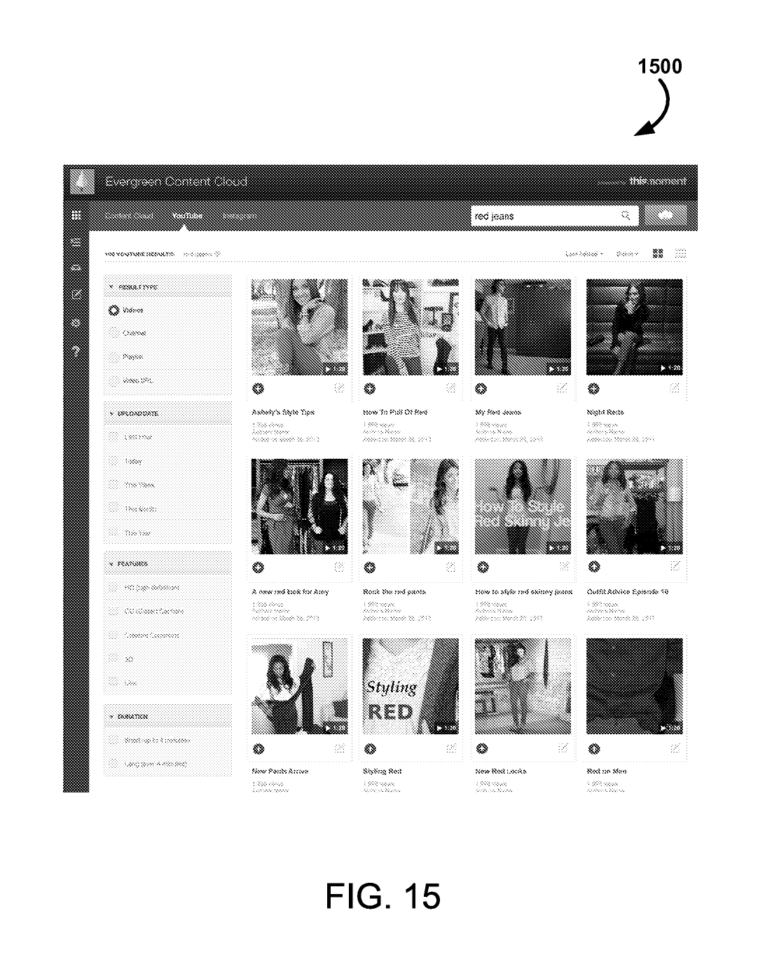

In contrast, FIG. 15 illustrates a dashboard for the searching and viewing of digital assets found on a digital assets platform (at 1500). In this example screenshot, two digital assets platforms are illustrated as being accessible: YouTube and Instagram. Of course, in alternate embodiments, other digital asset platforms may be accessible by the cloud-based digital asset management system. In some embodiments, the management system user may designate which digital asset platforms are to be accessed. As with the cloud dashboard, this digital asset platform dashboard enables filtering of the digital assets and searching of the digital assets in order to identify digital assets of interest.

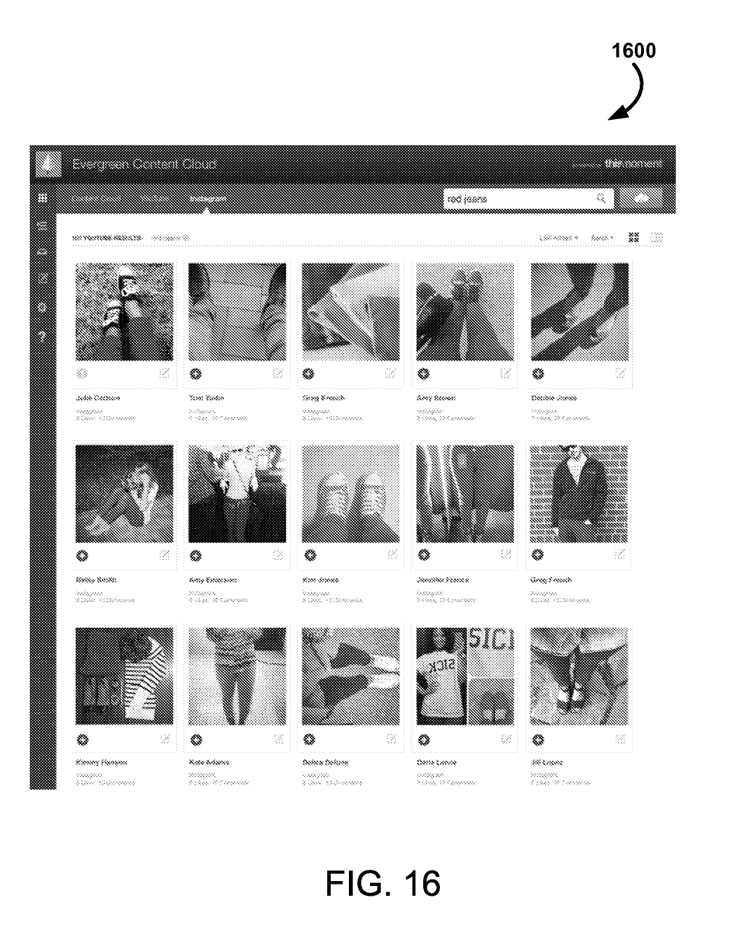

Likewise, FIG. 16 provides a dashboard for the second digital asset platform (at 1600). Since this digital asset platform does not support filtering, the filter side menu is omitted.

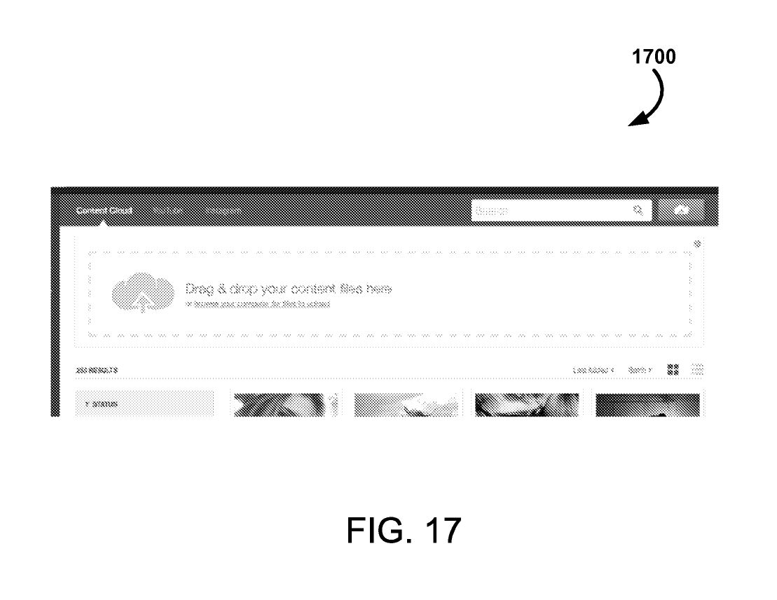

FIG. 17 provides a zoomed in screenshot of a registration field (at 1700). Here, the user may drag and drop digital assets of interest for registering into the cloud.

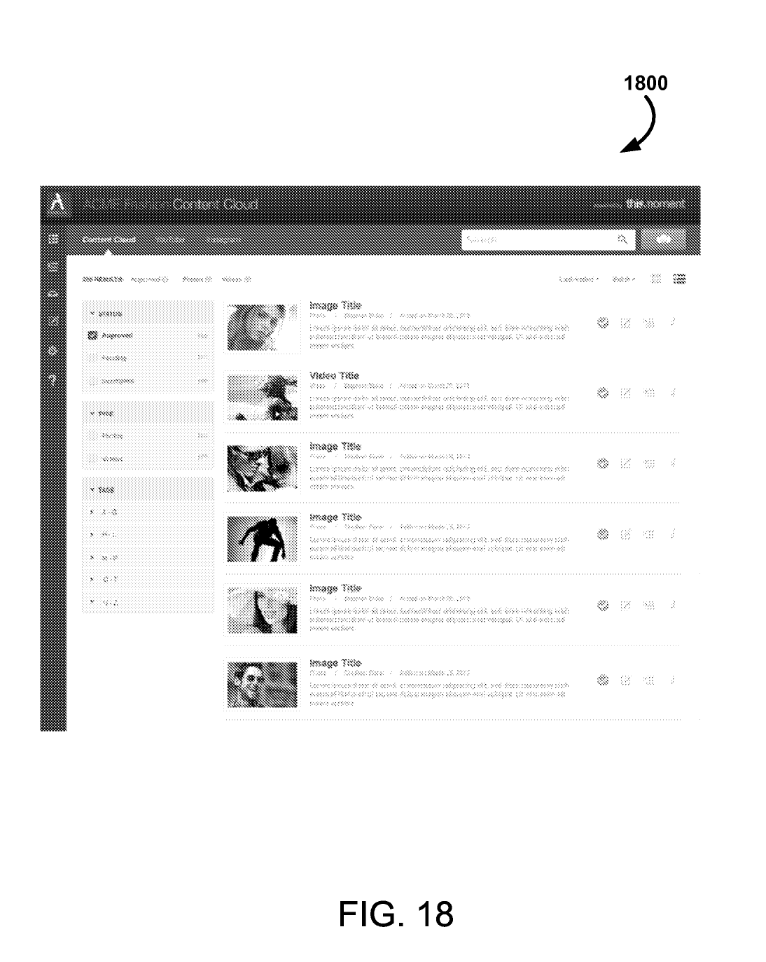

FIG. 18 provides another view of the cloud-based digital asset management system dashboard (at 1800). In this example view the digital assets are provided in list format. Each digital asset entry includes an image (where applicable), a title, type, source, user who provided the digital asset, date of digital asset generation, and a description. Additionally, digital asset status is displayed. Digital asset status may include pending, approved, or expired. Digital asset metadata may also be updated, and details be viewed.

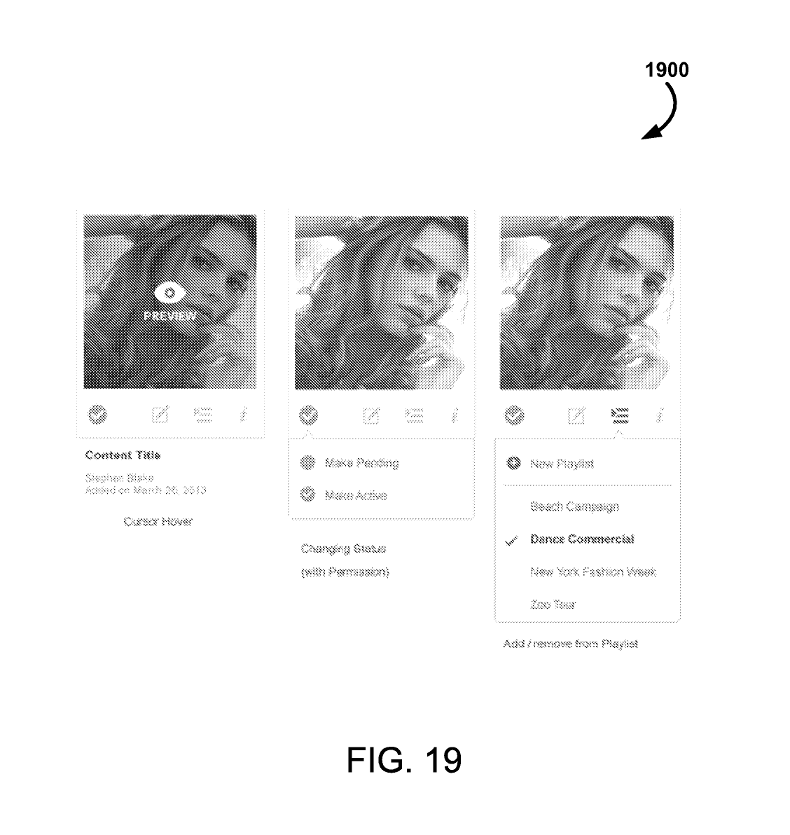

FIG. 19 provides a series of screenshots (at 1900) of a digital asset in tabular format. When the cursor is hovered over the digital asset a preview may be provided. The management system user has the option of configuring the digital asset status as pending or approved/active. The user may also select a playlist for the digital asset.

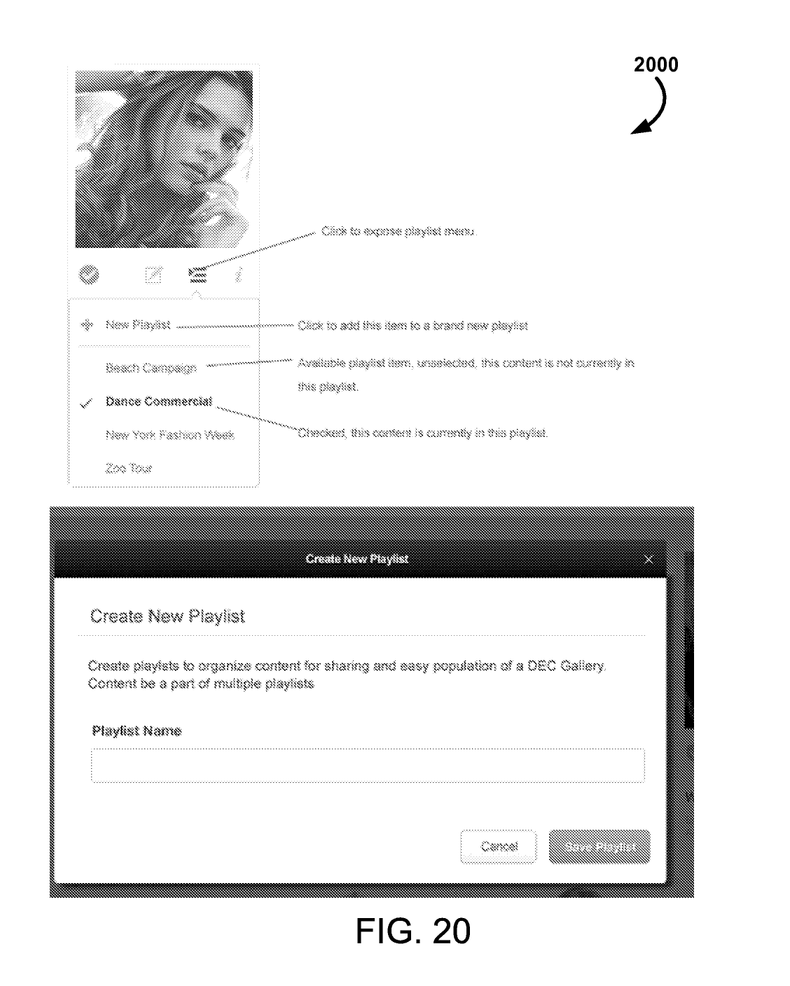

FIG. 20 illustrates the means for assigning a digital asset to a playlist (at 2000). The playlist icon can be selected to display a drop down menu of existing playlists. The management system user has the option of creating a new playlist, or selecting from a current playlist. If the new playlist is selected, a playlist screen is presented (as shown). The management system user inputs a playlist name in order to generate the new playlist.

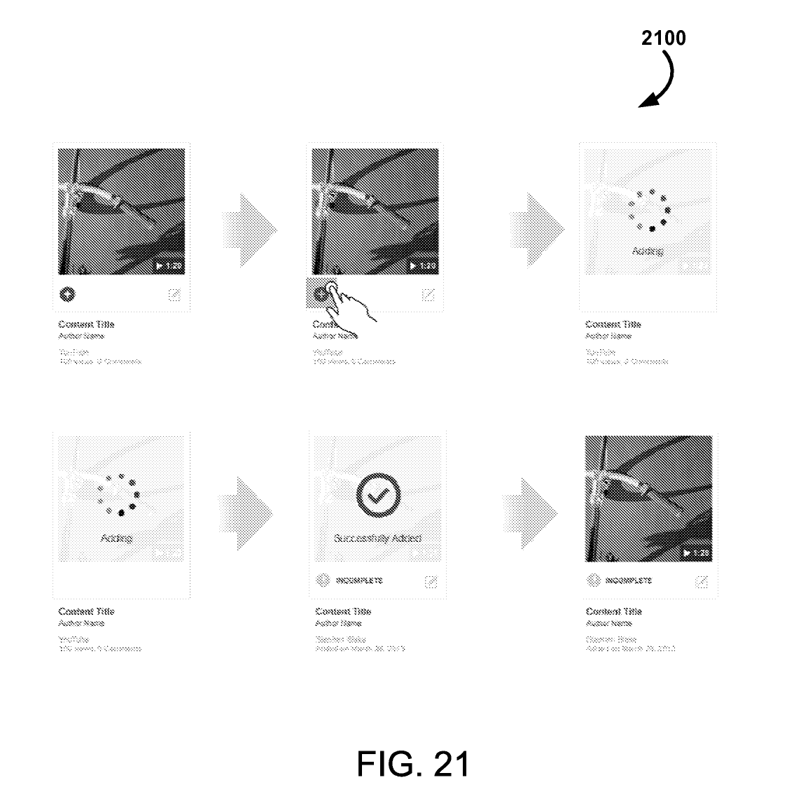

Turning to FIG. 21, a series of screenshots (at 2100) are provided for the addition of digital asset of interest to the cloud-based digital asset management system. In these example screenshots the digital asset is shown. The management system user selects the “+” symbol to register the digital asset to the system. The digital asset is added and a confirmation is displayed to the management system user. The management system user is then returned to the previous digital asset view so that additional digital assets may be registered. However, the digital asset is no longer shown as being eligible for registering. An incomplete icon is provided to communicate to the user that additional information is needed for the registered digital asset. Typically, incomplete status is provided when insufficient metadata is present. Once the additional metadata is provided (or if there is sufficient metadata initially) the digital asset is flagged as pending.

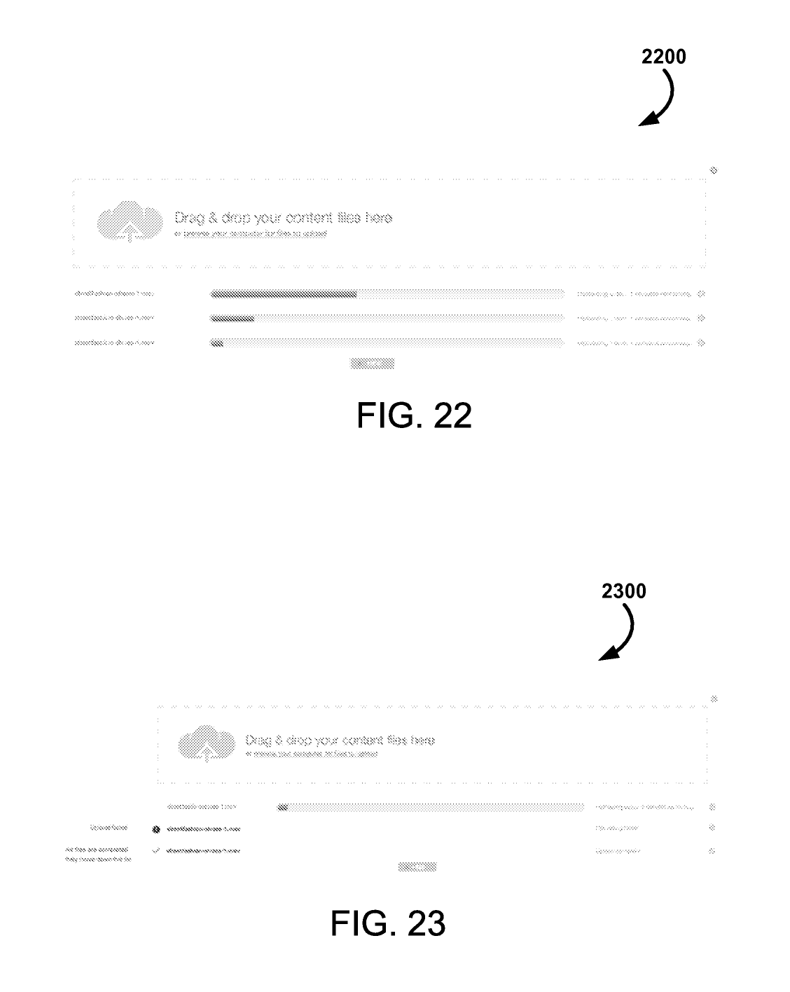

FIG. 22 provides a display (at 2200) of where a digital asset has been selected for registering into the cloud (either via one-click or via drag and drop to the register field). Here the digital asset being registered provides a status bar of registration progress. Digital assets that have registered successfully may indicate successful registration, as shown in FIG. 23 (at 2300). Alternatively, an error message may be displayed when digital asset is not registered properly.

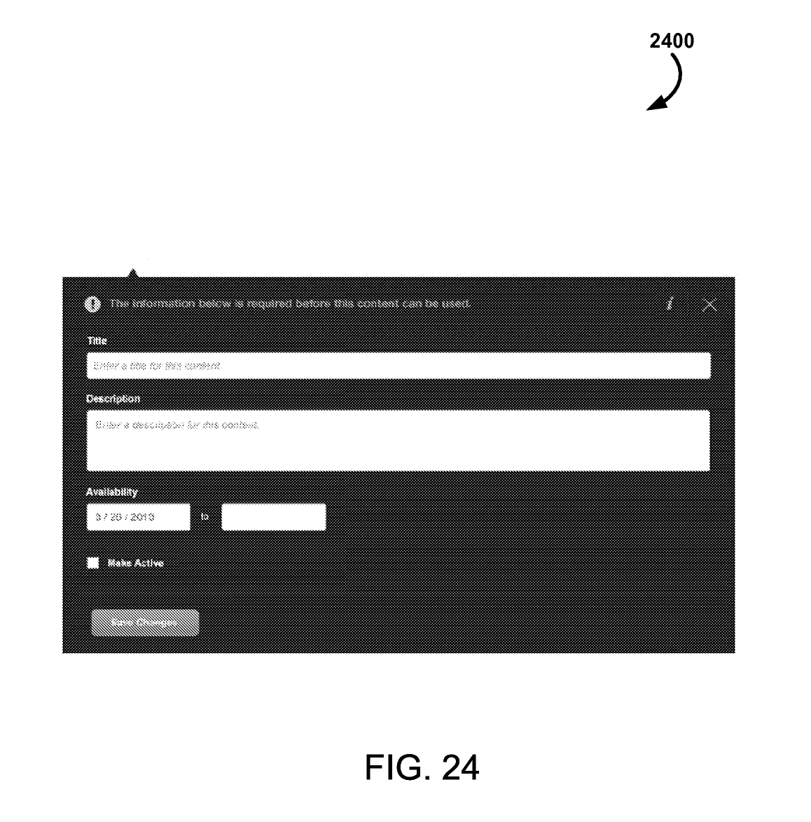

After a digital asset has been registered, but it is considered incomplete due to missing metadata, the management system user may be requested to provide the additional metadata. FIG. 24 provides a screenshot for this additional data request (at 2400). Here, a minimum of a title, a description and an availability range are required. In alternate embodiments, more or less metadata may be required to complete a digital asset register.

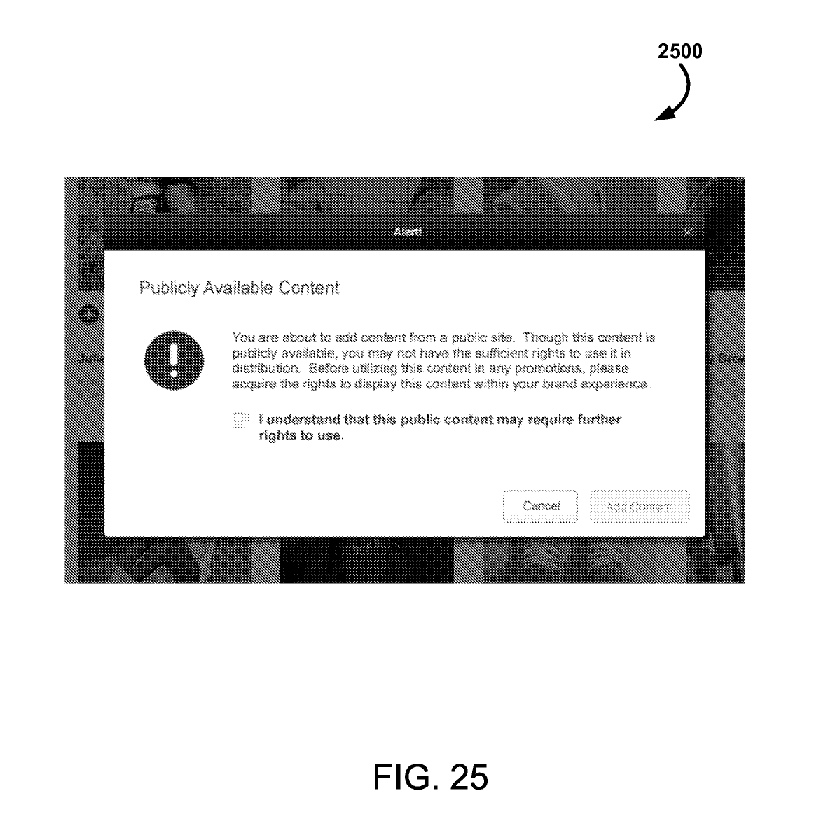

FIG. 25 provides a warning screenshot (at 2500) for when digital assets obtained from consumers or from third-party digital assets platforms or social networks is registered. This legal feature reminds the user that digital assets may be subject to additional rights before it may be registered.

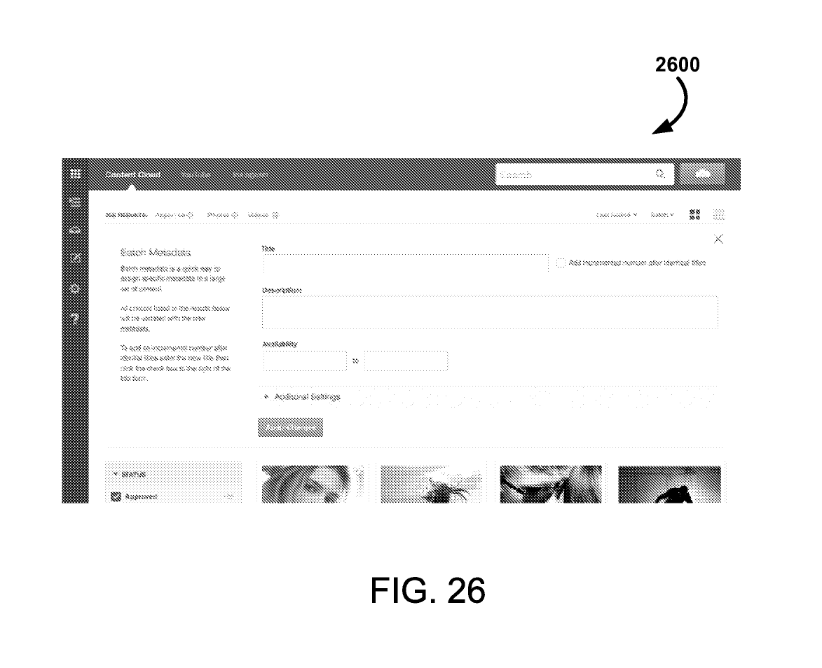

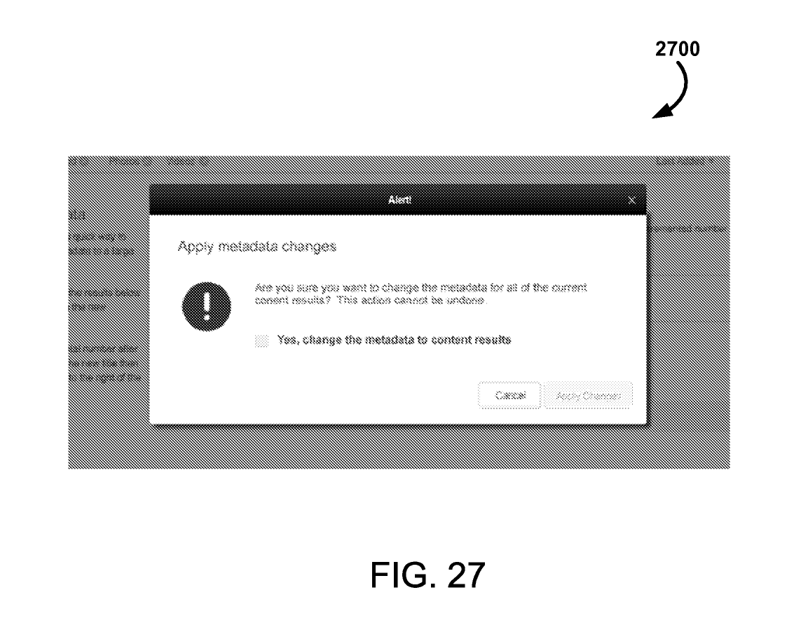

FIG. 26 provides an example screenshot for a mechanism to batch update metadata for a group of updated digital assets (at 2600). The management system user has the ability to select a batch update whereby the title, description, availability date and other information may be altered for a grouping of digital assets. After indicating a batch metadata update, the system may confirm the change with management system the user via a confirmation page (at 2700) as seen in FIG. 27.

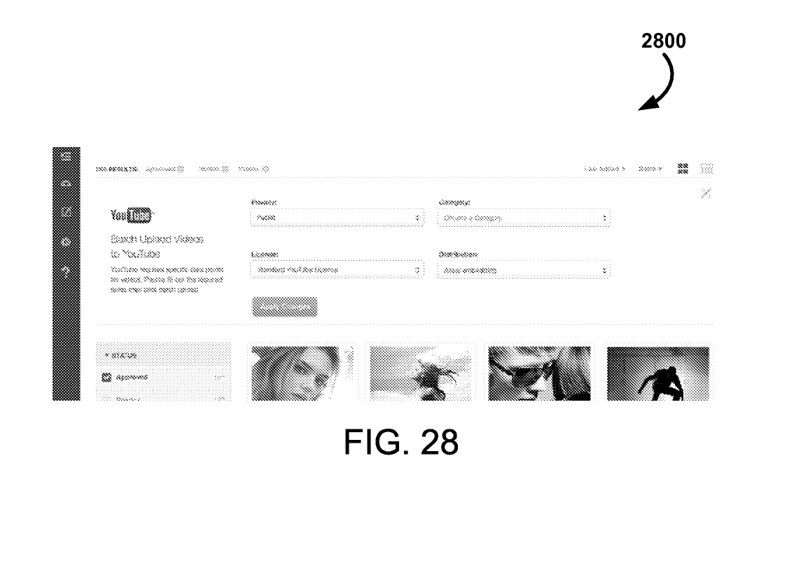

Turning to FIG. 28, a screenshot for a batch publishing of videos to YouTube is illustrated (at 2800). Here the username, privacy setting, category and distribution may be assigned by the user for the batch register.

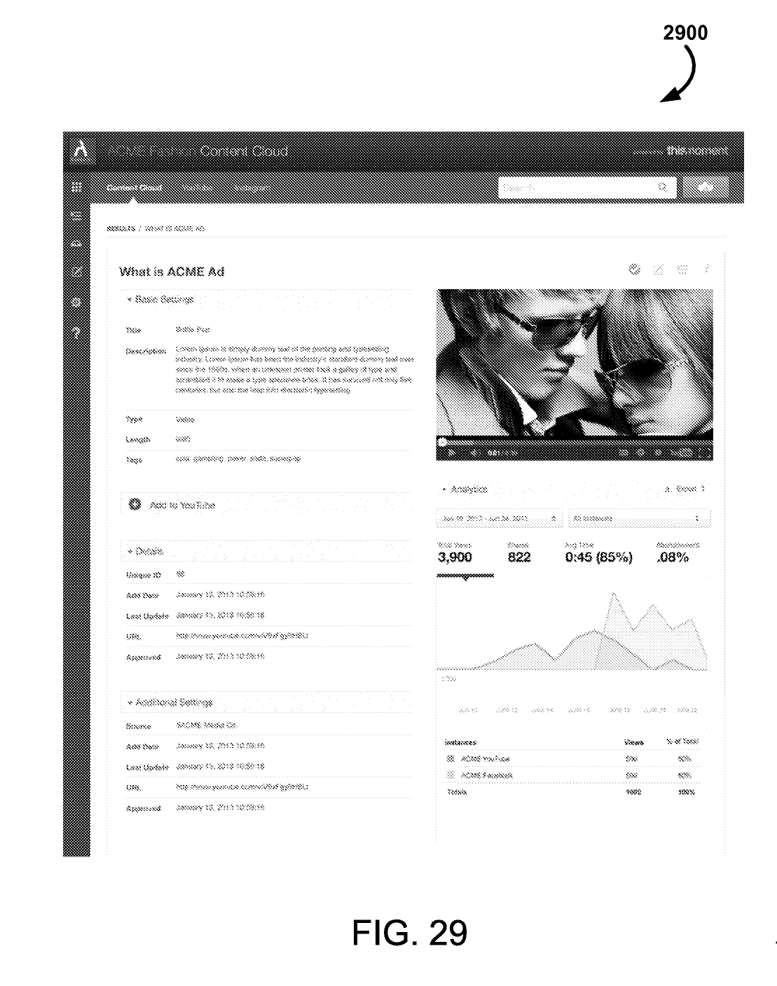

FIG. 29 illustrates a report screen for registered digital assets (at 2900). In addition to providing details regarding the digital assets, analytics of views, shares, average time viewed and abandonment are provided. In alternate embodiments, additional analytics may be provided.

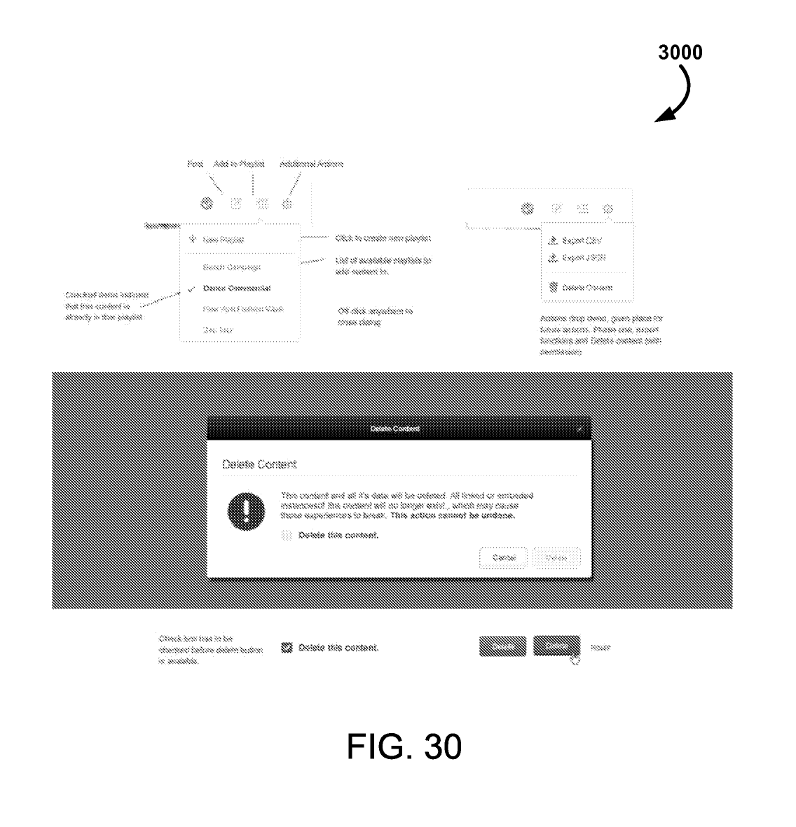

FIG. 30 provides an example screenshot for the deleting of digital assets from the cloud-based digital asset management system (at 3000). Here the user selects an additional services icon and selects delete digital asset. A confirmation popup clarifies that the user actually intended to delete the digital asset.

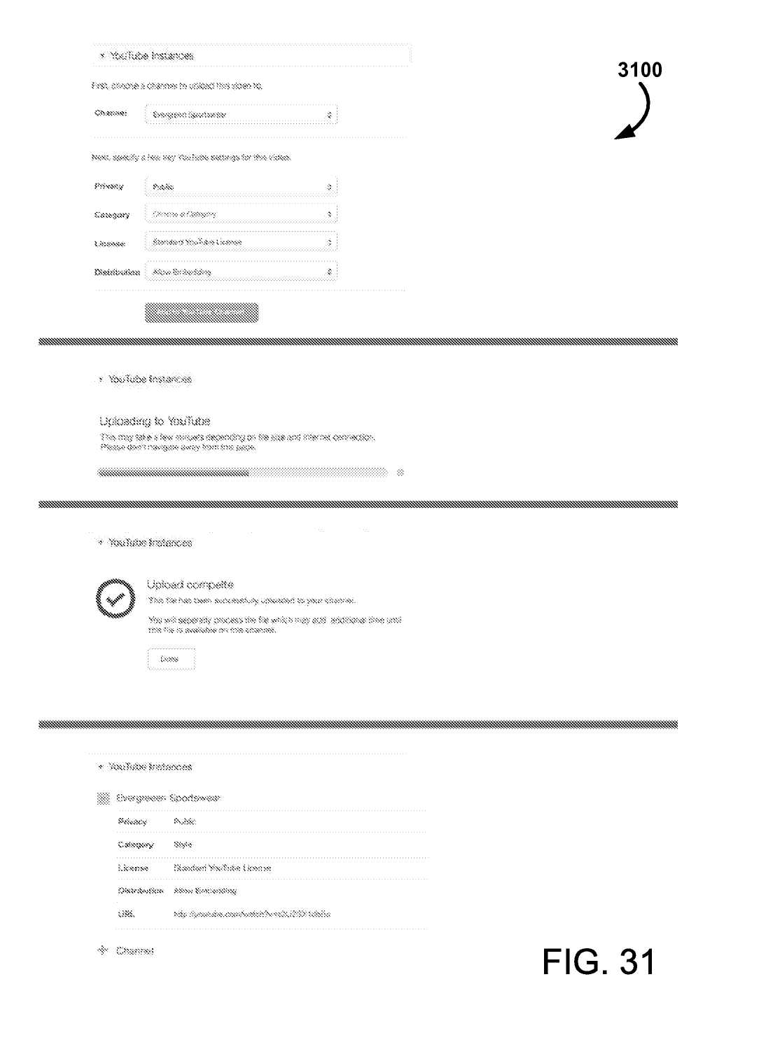

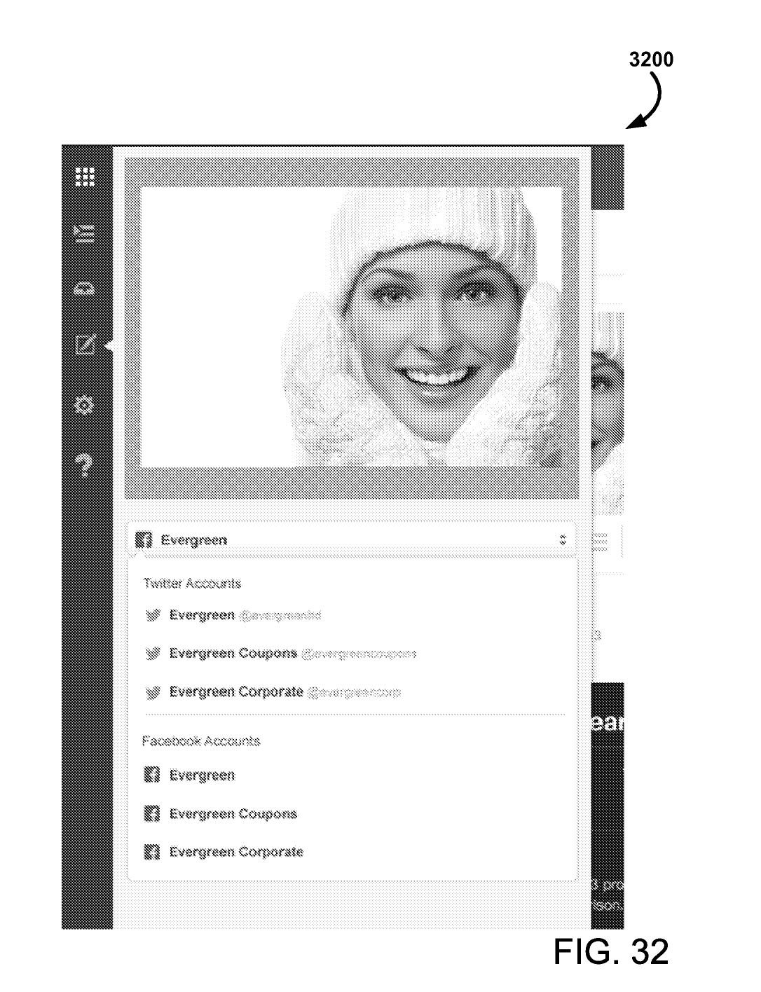

FIG. 31 provides a series of screenshots for the publishing of a single article of a digital asset to a digital asset platform (at 3100). Initially, the channel, privacy setting, category, location and distribution settings are configured. Then the file registers (with progress bar). A confirmation of the file being successfully registered is provided, followed by a detailing of the registered digital asset.

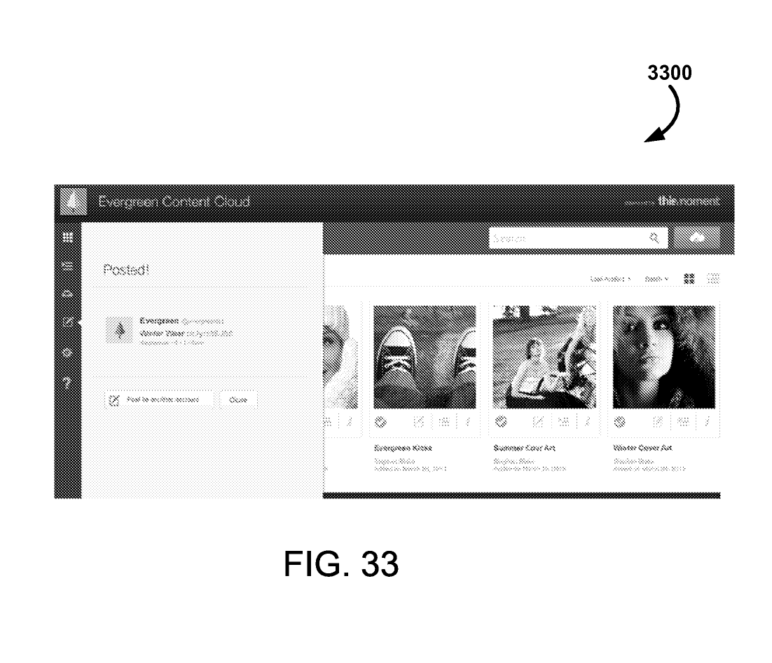

FIG. 32 provides a screenshot of a digital asset selected for one-click publishing (at 3200). In this example, the digital asset has been selected, thereby expanding the sidebar with publishing accounts. The management system user is able to select an account from the drop down menu to which the digital assets will publish. These accounts have previously been linked with the user ID within the cloud-based digital asset management system. Based upon the digital asset platform the digital assets are being registered to, an auto fill system may generate short titles, links, or other needed information. Only one account may be selected in one embodiment. In alternate embodiments, the user may simultaneously publish to a multitude of accounts. After selecting the account(s) the digital asset registers, and a confirmation may be presented to the user, as seen in FIG. 33 (at 3300).

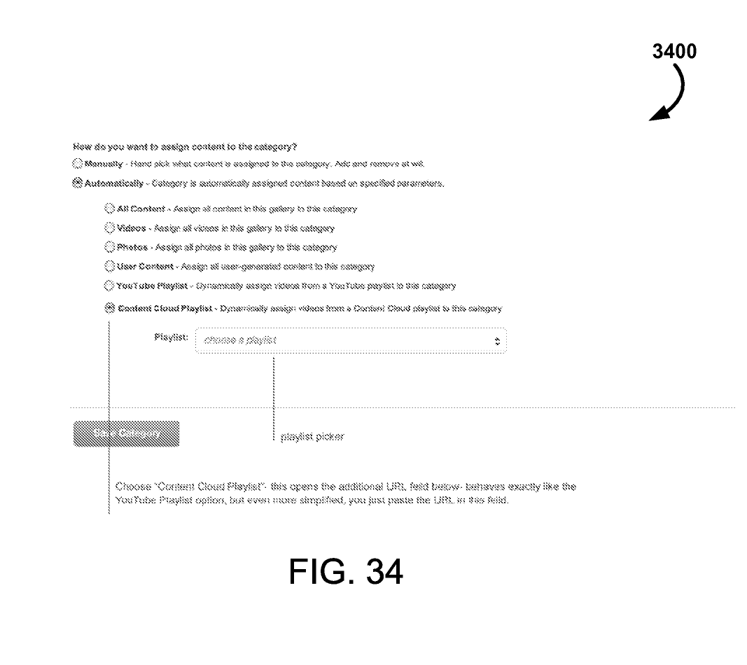

FIG. 34 provides a screenshot (at 3400) for cross functionality between the cloud-based digital asset management system, and the distributed engagement channels, discussed above in relation to automated channel addition. In this example, the management system user ties playlists to a distributed engagement channel. The management system user also has the ability to automatically categorize digital assets to the distributed engagement channel playlist. Only playlists with approved digital assets are displayed to the end-user (?), and digital assets within the playlists are read-only to ensure that only changes are made within the distributed engagement channel. When so configured, digital assets are automatically synched between the distributed engagement channel and the cloud-based digital asset management system when changes are made within the distributed engagement channel. In some embodiments, a single cloud-based digital asset management system may be tied to multiple distributed engagement channels.

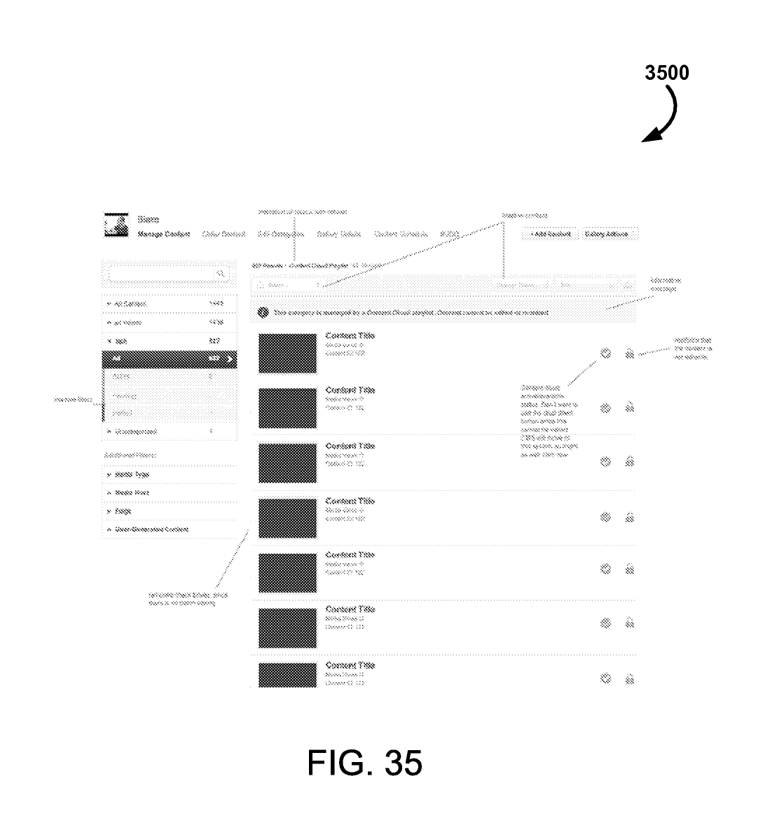

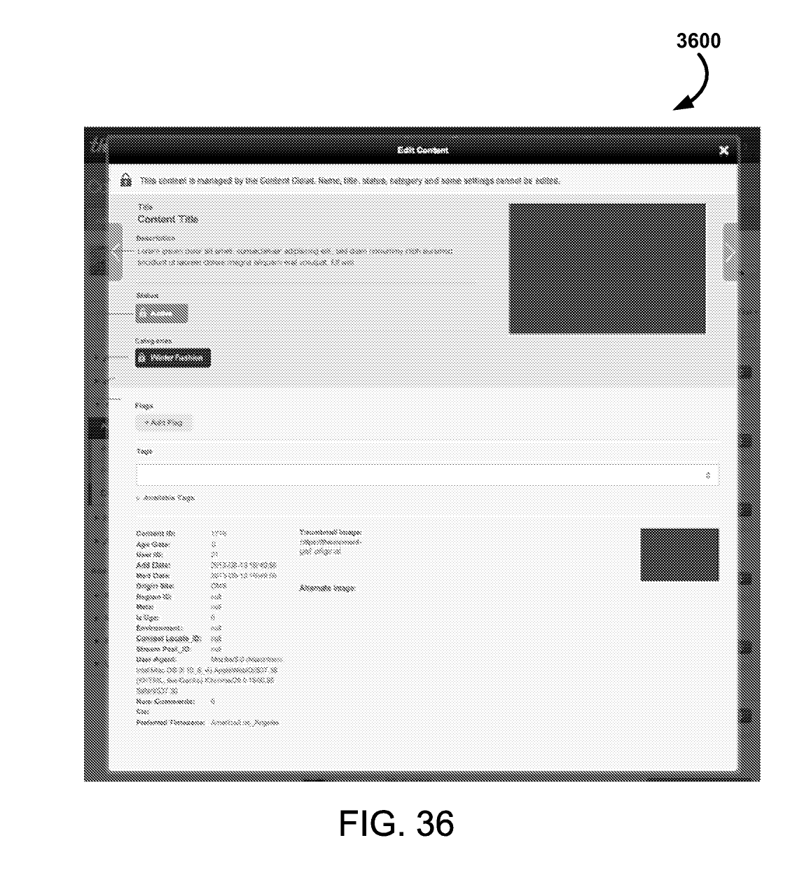

FIG. 35 illustrates a management screen for distributed engagement channels which are tied to the cloud-based digital asset management system (at 3500). As noted above, the digital assets cannot be edited within the cloud; edits made in the distributed engagement channel automatically synch with the cloud periodically. At FIG. 36 a detailed display of digital assets found within a playlist tied to a distributed engagement channel is provided (at 3600).

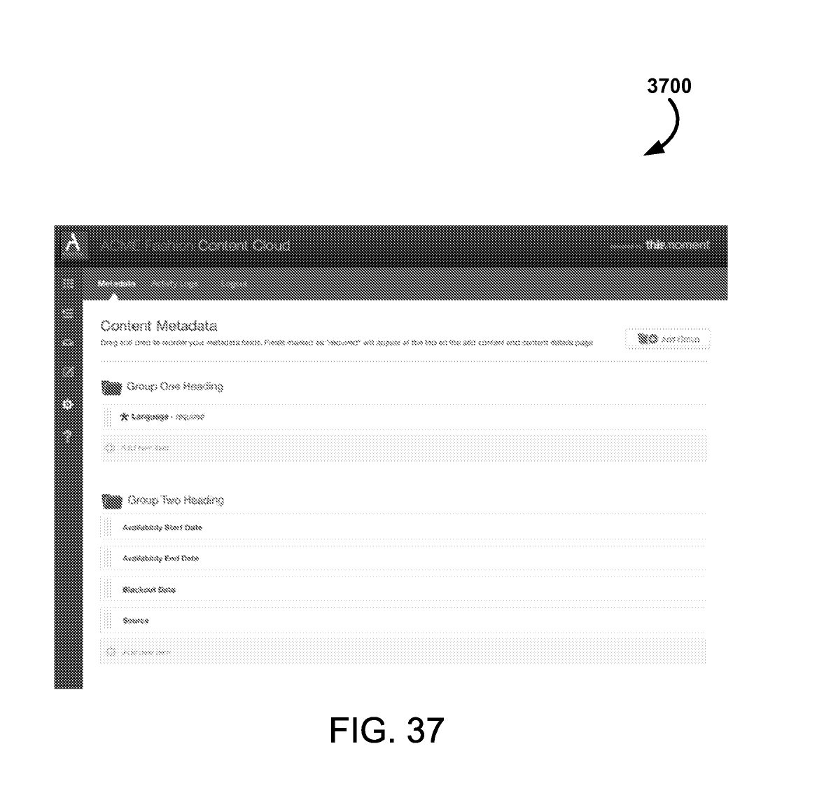

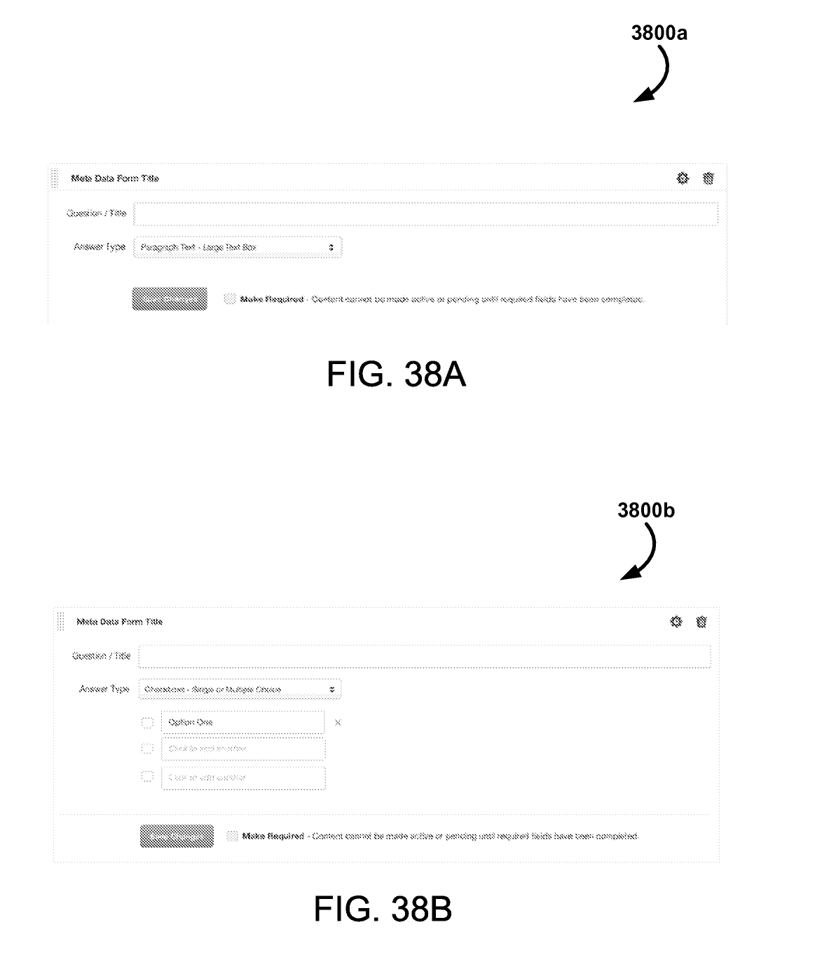

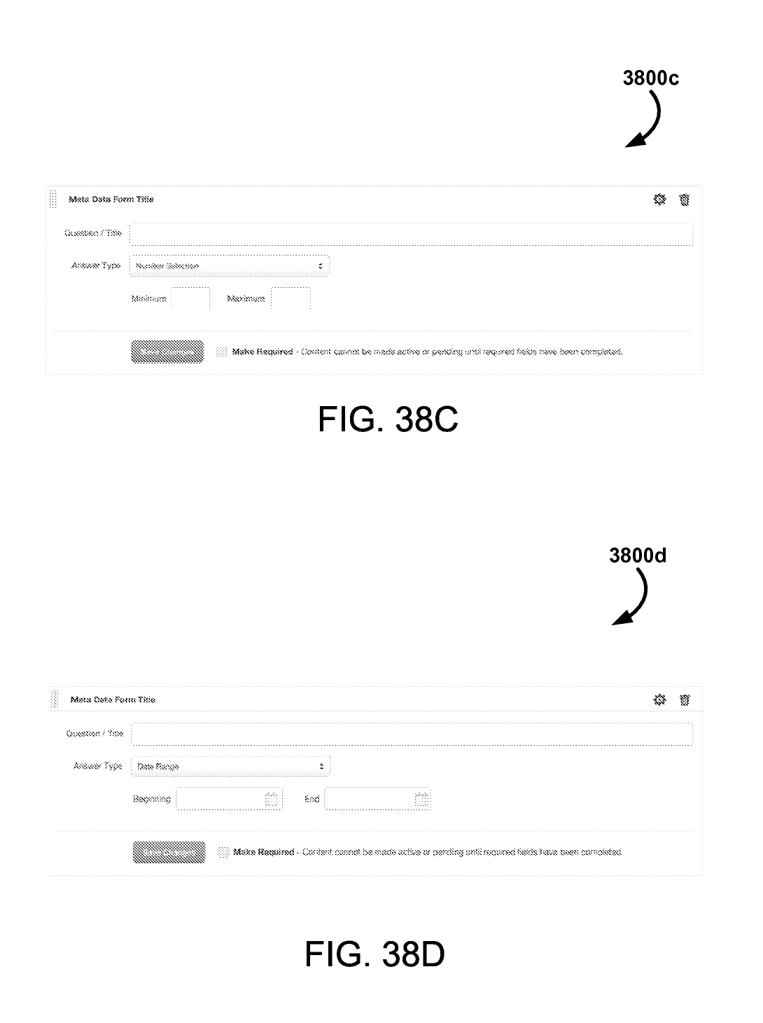

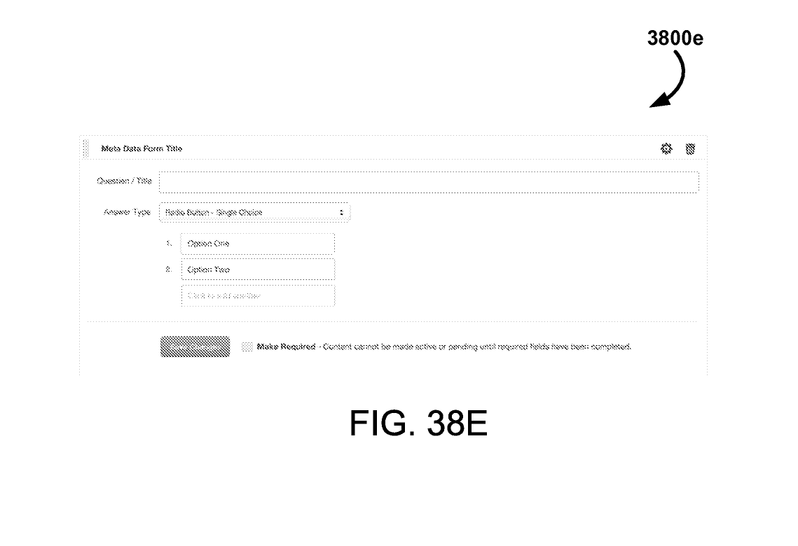

FIG. 37 provides a landing page for metadata administration (at 3700). In this example page, fields may be dragged and dropped into appropriate files to record metadata configurations. Metadata groupings may be added by the content system user. FIG. 38A illustrates the first step in a metadata group addition (at 3800a). Here a question is inputted by the management system user, and an answer type is designated. FIG. 38B illustrates the where the answer type has been changed from a text input to a single or multiple choice (checkbox) input (at 3800b). FIG. 38C illustrates the where the answer type has been changed to a number selection input (at 3800c). FIG. 38D illustrates the where the answer type has been changed to a date range input (at 3800d). FIG. 38E illustrates the where the answer type has been changed to a radio button input (at 3800e).

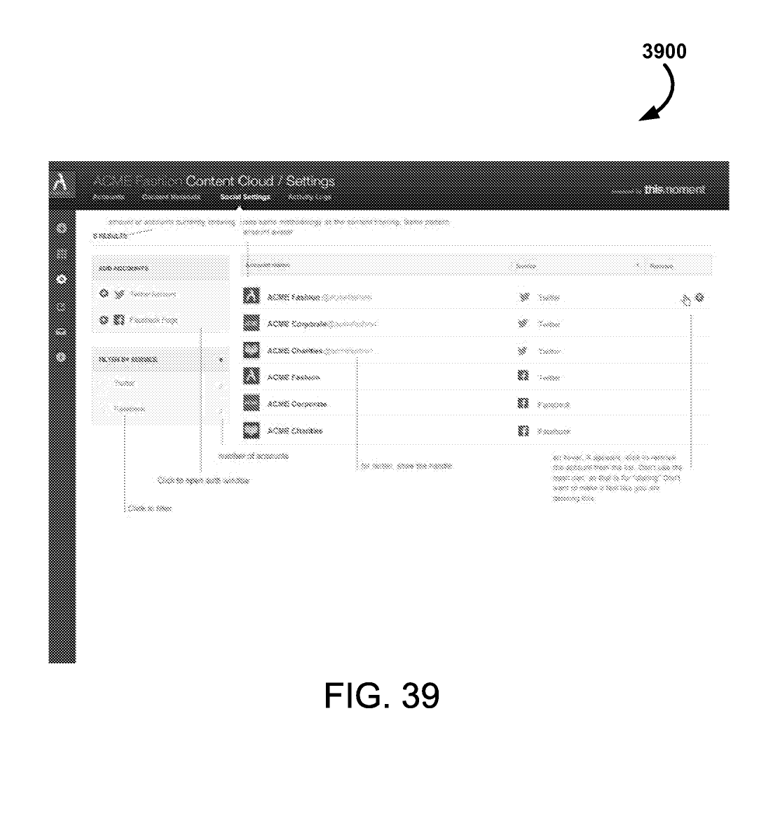

FIG. 39 provides an example landing page for management of social accounts (at 3900). Within this page a management system user may add, delete and manage social media accounts. This ties the cloud to the account thereby enabling seamless publishing to the social media platform.

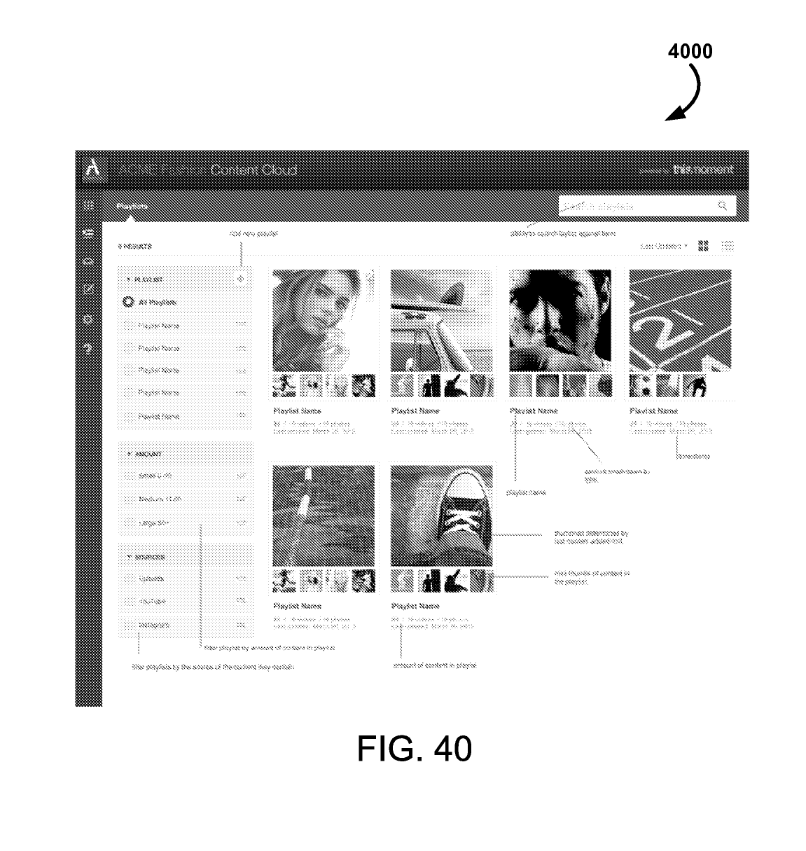

Lastly, FIG. 40 provides a playlist page (at 4000). The playlist page shows all compiled playlists. Here playlists may be sorted and searched. The playlists are displayed with mini thumbnail images of digital assets within the playlists, along with the playlist name and a summary of the digital asset numbers and types within the respective playlist. By selecting a playlist, the user is redirected to the playlist page, which resembles the browsing page. Within the playlist page, digital assets may be edited, added or removed. Digital asset ordering within the playlist may also be updated.

### V. System Embodiments

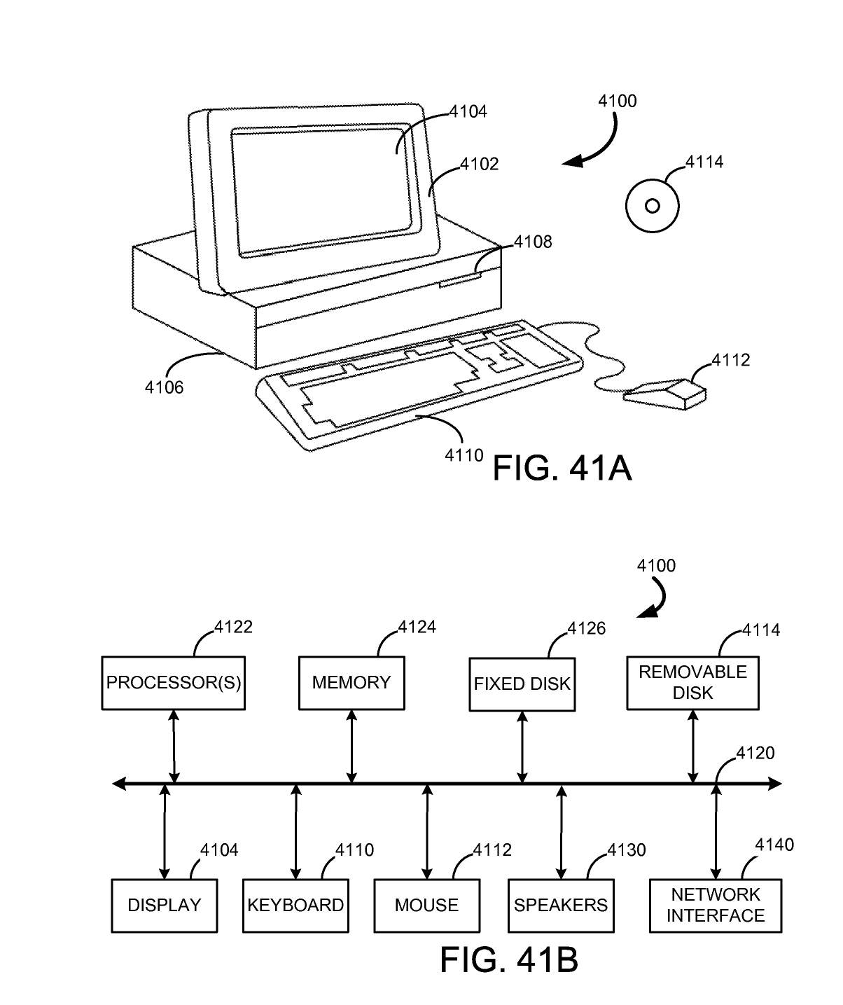

FIGS. 41A and 41B illustrate a Computer System 4100, which is suitable for implementing embodiments of the present invention. FIG. 41A shows one possible physical form of the Computer System 4100. Of course, the Computer System 4100 may have many physical forms ranging from a printed circuit board, an integrated circuit, and a small handheld device up to a huge super computer. Computer system 4100 may include a Monitor 4102, a Display 4104, a Housing 4106, a Disk Drive 4108, a Keyboard 4110, and a Mouse 4112. Disk 4114 is a computer-readable medium used to transfer data to and from Computer System 4100.

FIG. 41B is an example of a block diagram for Computer System 4100. Attached to System Bus 4120 are a wide variety of subsystems. Processor(s) 4122 (also referred to as central processing units, or CPUs) are coupled to storage devices, including Memory 4124. Memory 4124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 4126 may also be coupled bi-directionally to the Processor 4122; it provides additional data storage capacity and may also include any of the computer-readable media described below. Fixed Disk 4126 may be used to store programs, data, and the like and is typically a secondary storage medium (such as a hard disk) that is slower than primary storage. It will be appreciated that the information retained within Fixed Disk 4126 may, in appropriate cases, be incorporated in standard fashion as virtual memory in Memory 4124. Removable Disk 4114 may take the form of any of the computer-readable media described below.

Processor 4122 is also coupled to a variety of input/output devices, such as Display 4104, Keyboard 4110, Mouse 4112 and Speakers 4130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 4122 optionally may be coupled to another computer or telecommunications network using Network Interface 4140. With such a Network Interface 4140, it is contemplated that the Processor 4122 might receive information from the network, or might output information to the network in the course of performing the above-described cloud-based digital asset management system. Furthermore, method embodiments of the present invention may execute solely upon Processor 4122 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present invention provides systems and methods for a cloud-based digital asset management system. Such systems and methods enable marketers, brand managers and users to seamlessly consolidate and manage digital assets from a wide variety of digital asset platforms, and further enables publishing of said digital assets to various digital asset platforms with ease.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for cloud-based digital asset management, useful in conjunction with digital asset platforms, the method comprising:
accessing at least one digital asset platform; and
registering, using a processor, digital assets from the at least one digital asset platform, where in the registered digital assets includes metadata and has a pending status.

2. The method of claim 1, further comprising setting the digital asset status to approved.

3. The method of claim 2, further comprising publishing the approved digital assets to at least one digital asset platform.

4. The method of claim 3, further comprising placing the digital assets into appropriate cards prior to publishing, wherein the cards consist of wrappers including functionality.

5. The method of claim 4, further comprising placing the digital assets into appropriate cards prior to publishing, wherein the cards consist of wrappers including functionality appropriate to each of the at least one digital asset platform.

6. The method of claim 1, further comprising categorizing the digital assets into at least one playlist.

7. The method of claim 6, wherein at least one playlist is associated with a distributed engagement channel.

8. The method of claim 1, further comprising associating a user ID to at least one social media account.

9. The method of claim 8, further comprising one-click publishing of digital assets to the at least one social media account.

10. The method of claim 1, further comprising batch publishing of the digital assets to a digital asset platform.

11. The method of claim 1, further comprising generating analytics for the digital assets.

12. The method of claim 11, wherein the analytics include at least one of unique views, new views, geographic distribution of viewers, amount of time a video is viewed, video view drop rates, social sharing metrics, and contextual impressions.

13. A system for cloud-based digital asset management, useful in conjunction with digital asset platforms, the system comprising:
an application program interface, executed using a processor, configured to access at least one digital asset platform, and register digital assets from the at least one digital asset platform, where in the registered digital assets includes metadata and has a pending status.

14. The system of claim 13, further comprising a user interface configured to set the digital asset status to approved.

15. The system of claim 14, further comprising a publisher configured to publish the approved digital assets to at least one digital asset platform.

16. The system of claim 15, wherein the publisher is configured to place the digital assets into appropriate cards prior to publishing, wherein the cards include wrappers including functionality appropriate to each of the at least one digital asset platform.

17. The system of claim 13, further comprising a playlist module configured to categorize the digital assets into at least one playlist.

18. The system of claim 17, wherein at least one playlist is associated with a distributed engagement channel.

19. The system of claim 13, further comprising an administrative module configured to associate a user ID to at least one social media account.

20. The system of claim 19, further comprising a publisher configured to one-click publish the digital assets to the at least one social media account.

21. The system of claim 13, further comprising a publisher configured to batch publish the digital assets to a digital asset platform.

22. The system of claim 13, further comprising a reporter configured to generate analytics for the digital assets.

23. The system of claim 22, wherein the analytics include at least one of unique views, new views, geographic distribution of viewers, amount of time a video is viewed, video view drop rates, social sharing metrics, and contextual impressions.
